(19) United States
(12) Patent Application Publication
(10) Pub. No.: US 2018/0143373 A1
(43) Pub. Date: May 24, 2018

(54) MULTIMODE OPTICAL FIBERS AND METHODS FOR PROVIDING A LIGHT TRANSMISSION SYSTEM USING SUCH FIBERS

(71) Applicant: LEIBNIZ-INSTITUT FÜR PHOTONISCHE TECHNOLOGIEN e.V., Jena (DE)

(72) Inventor: Tomá{hacek over (s)} CIZMÁR, Central Scotland (GB)

(21) Appl. No.: 15/579,015

(22) PCT Filed: Jun. 1, 2016
(86) PCT No.: PCT/GB2016/051602

§ 371 Date: Dec. 1, 2017

(30) Foreign Application Priority Data
Jun. 1, 2015 (GB) 1509418.8

(51) Int. Cl. G02B 6/028; G02B 27/00; G02B 23/26; G06F 17/18

(52) U.S. Cl. CPC G02B 6/0288; G02B 27/0012; G06F 2217/16; G06F 17/18; G02B 23/26

(57) ABSTRACT

Methods for providing a light transmission system using a multimode optical fiber can be provided, in which the light transmission properties of the multimode optical fiber are predicted by numerically modelling the transmission matrix of a specific fiber. An exemplary method of making a light transmission system can also be provided, whereas the multimode optical fiber can be provided, the light transmission properties of the multimode optical fiber can be predicted, and the multimode optical fiber can be coupled to a light source and to a light detector in a manner determined by the prediction.

### RELATED APPLICATION(S)

The present application is a national phase of International Application No. PCT/GB2016/051602 filed on Jun. 1, 2016, which published as International Patent Publication WO 2016/193718 on Dec. 8, 2016, which claims priority to German Patent Application No. 1509418.8 filed on Jun. 1, 2015, the entire disclosures of which are incorporated herein by reference.

### FIELD OF THE DISCLOSURE

The present disclosure relates to the use, design and implementation of multimode optical fibers, and to instruments and systems using such fibers. For example, the exemplary embodiments of the present disclosure can be used in imaging instruments, such as, e.g., endoscopes, as well as in communication systems.

### BACKGROUND INFORMATION

In a similar fashion to diffusers or other highly scattering media, multimode fibers (MMF) deliver coherent light signals in the form of apparently random speckled patterns. In contrast to other random environments in which light propagates along complex paths, MMF features remarkably faithful cylindrical symmetry.

The theoretical description of light transport processes within ideal MMFs has been developed for over half a century [see, e.g., Refs. 1-4]. This elaborate theoretical model is, however, frequently considered inadequate to describe real life MMFs that are manufactured by drawing melted silica preforms. Such fibers are commonly seen as unreliable and the inherent randomization of light propagating through them is typically attributed to undetectable deviations from the ideal fiber structure. It is a commonly held belief that this additional chaos is unpredictable and that its influence grows with the length of the fiber. Despite this, light transport through MMFs remains deterministic.

The prospect of deterministic light propagation within MMF has only recently been utilized through methods of digital holography and by adopting the concept of empirical measurement of the transformation matrix (TM) [see, e.g., Refs. 5-11]. This technique, developed on studies of light propagation through highly turbid media [see, e.g., Refs. 12-17], has opened a new window of opportunities for MMFs to become extremely narrow and minimally invasive endoscopes, allowing sub-micrometer resolution imaging in deep regions of sensitive tissues [see, e.g., Ref 9 and 18]. However attractive, this technology suffers from several major limitations, the most critical being the lack of flexible operation: any bending or looping of the fiber results in changes to its TM, thus rendering imaging heavily impaired. All current methods exploiting MMFs for imaging require open optical access to the distal end of the fiber during the time consuming measurement of the TM. Furthermore, this characterization should be repeated upfront for every intended configuration (deformation) and any axial distance of focal plane behind the fiber before the system can be used for imaging [see, e.g., Refs. 7 and 19]. The importance to determine the TM empirically therefore constitutes a major bottleneck of the technology and it would be immensely advantageous to obtain the TM by another route, ideally on the basis of numerical modelling.

Experimental studies presented herein challenge the commonly held notion that classifies multimode fibers as unpredictable optical systems. Instead, it is demonstrated that commercially available MMFs are capable of performing as extremely precise optical components. For example, with a sufficiently accurate theoretical model, light propagation within straight or even significantly deformed segments of MMFs may be predicted up to distances in excess of hundreds of millimeters. Harnessing this newly discovered predictability in imaging, the unparalleled power of MMF-based endoscopes are demonstrated, which offer exceptional performance both in terms of resolution and instrument footprint. These exemplary results thus pave the way for numerous exciting applications, including high-quality imaging deep inside motile organisms.

It can be important to determine whether such modelling is feasible in the supposedly chaotic environment of multimode fibers that however, unlike other random media, feature a remarkable cylindrical symmetry. Indeed, numerous studies have already indicated that at least some aspects of the ordered behavior (propagation constants of modes) can ‘survive’ over very large distances [see, e.g., Refs. 20-23].

Exemplary embodiments of the present disclosure provide a major advancement on these efforts. For example, with the availability of experimentally measured TM stored in the memory of a computer, many or all light transport processes can be emulated with great accuracy and the optical fiber can be subjected to detailed investigation [see, e.g., Ref 24]. While working with relatively large numbers of modes (≈500), the shortest practical fiber segment (≈10 mm) can be used in order to minimize the complexity of the problem. This important intermediate step/procedure allows an elimination of influences caused by imperfections (unavoidable misalignment) in exemplary experimental settings, and importantly allows to establish parameters of the fiber (core diameter, numerical aperture) with sufficiently high precision.

When corrections for these aspects are implemented, it is possible to see a good agreement with the theoretical model used. This not only confirms the existence of propagation-invariant modes within the fiber but also very accurately matches their output phases, vitally important for imaging applications. Progressing to 100 mm-long fiber segments, the first challenges related to polarization coupling and significant deviations of refractive index from the ideal step-index profile have been faced, which required major enhancement of the exemplary numerical modelling and experimental methods.

Thus, the previous paragraphs describe some of the objects of the present disclosure and some of the deficiencies of the prior art that have been addressed by embodiments of the present disclosure.

With the exemplary ability to predict light propagation even through such distances within the fiber, exemplary embodiments of the present disclosure can facilitate a rigorous investigation of the influence of fiber deformation (bending) on the resulting TM. Exemplary embodiments of the present disclosure indicate that even significantly bent fibers are perfectly predictable, thus allowing computation of their TM based purely on the observation of the fiber geometry. Further, e.g., most or all of these new aspects can be brought together to test the performance of imaging in such an enhanced system. According to exemplary embodiments of the present disclosure, imaging can be achieved without experimental TM acquisition, in both straight and deformed fibers at an arbitrary distance behind the distal fiber facet.

### SUMMARY OF EXEMPLARY EMBODIMENTS

Accordingly, exemplary embodiments of the present disclosure can provide a method of designing a light transmission system using a multimode optical fiber, in which the light transmission properties of the fiber are predicted by numerically modelling the transmission matrix of a given fiber.

In another exemplary embodiment of the present disclosure, a method can be provided for making a light transmission system According to such exemplary method, it is possible to provide a multimode optical fiber, predict the light transmission properties of the fiber by the foregoing method, and couple the fiber to a light source and to a light detector in a manner determined by the prediction.

The light transmission system may be incorporated in an endoscope, or a signal transmission system, according to yet another exemplary embodiment of the present disclosure.

These and other objects, features and advantages of the exemplary embodiments of the present disclosure will become apparent upon reading the following detailed description of the exemplary embodiments of the present disclosure, when taken in conjunction with the appended drawings and claims.

### BRIEF DESCRIPTION OF THE DRAWINGS

Further objects, features and advantages of the present disclosure will become apparent from the following detailed description taken in conjunction with the accompanying figures showing illustrative embodiments of the present disclosure, in which:

FIG. 1a is an illustration an analysis of a short segment of fiber providing an organization of input and output modes, according to an exemplary embodiment of the present disclosure;

FIG. 1b is an illustration an analysis of a short segment of fiber providing experimentally measured TM, according to an exemplary embodiment of the present disclosure;

FIG. 1c is an illustration an analysis of a short segment of fiber providing theoretically predicted LP PIMs, according to an exemplary embodiment of the present disclosure;

FIG. 1d is an illustration an analysis of a short segment of fiber providing a conversion matrix between the representation of FPs and LP PIMs, according to an exemplary embodiment of the present disclosure;

FIGS. 1e and 1f are illustrations an analysis of a short segment of fiber providing converted TM before and after the optimization procedure, respectively, according to an exemplary embodiment of the present disclosure;

FIG. 2a is an illustration of polarization coupling effects in MMF of data for the 10 mm long fiber for TM of LP PIMs, according to an exemplary embodiment of the present disclosure;

FIG. 2b is an illustration of Poincaré sphere depicting polarization change of LP PIMs, according to an exemplary embodiment of the present disclosure;

FIG. 2c is an illustration of projections of the LP PIMs polarization state on the mode pyramid, according to an exemplary embodiment of the present disclosure;

FIGS. 2d-2f are illustrations similar to those of FIGS. 2a-2c for the 100 mm long fiber, according to an exemplary embodiment of the present disclosure;

FIGS. 2g-2i are illustrations of data for the 100 mm long fiber using CP PIMs, according to an exemplary embodiment of the present disclosure;

FIG. 2j is an illustration of an experimentally measured phase difference between CP PIMs having opposite spin (the influence of SOI), according to an exemplary embodiment of the present disclosure;

FIG. 2k is an illustration of a numerically simulated equivalent of the illustration of FIG. 2j, according to an exemplary embodiment of the present disclosure;

FIG. 2l is an illustration of the CP PIMs output amplitude, according to an exemplary embodiment of the present disclosure;

FIG. 2m is an illustration of experimental synthesis of input PIMs and their corresponding output, according to an exemplary embodiment of the present disclosure;

FIG. 3a is an illustration of data for the 10 mm long fiber for experimentally measured phases, e.g., optical phases of PIMs, according to an exemplary embodiment of the present disclosure;

FIGS. 3b and 3c are illustrations of such data for the phases predicted by numerical model, unwrapped and 2π-wrapped, respectively, according to an exemplary embodiment of the present disclosure;

FIG. 3d is an illustration of such data for the difference between phases experimentally measured and theoretically predicted, according to an exemplary embodiment of the present disclosure;

FIG. 3e is an illustration of the data for the phase agreement, according to an exemplary embodiment of the present disclosure;

FIG. 3f-3h are illustration of data for the 10 mm long fiber for an assumed profile of refractive index, phase agreement and difference between experimentally obtained and theoretically predicted phases of PIMs respectively for the case of ideal step-index fiber, according to an exemplary embodiment of the present disclosure;

FIGS. 3i-3j are illustrations of the data that corresponds to a model with included dopant diffusion, according to an exemplary embodiment of the present disclosure;

FIGS. 3l-3n are illustrations of the data representing a correction for diffusion as well as fine index modulation across the fiber core, according to an exemplary embodiment of the present disclosure;

FIGS. 3o-3q are illustrations of the data similar to those of FIGS. 3l-3n for a 300 mm long fiber, according to an exemplary embodiment of the present disclosure;

FIG. 4a is an illustration of an influence of fiber deformation of arrangements of deformed fiber used in the experiment with their Roman ID number, according to an exemplary embodiment of the present disclosure;

FIGS. 4b and 4c are illustrations of experimentally measured and theoretically predicted DO corresponding to deformation (V), according to an exemplary embodiment of the present disclosure;

FIG. 4d is an illustration of an empiric estimation of scaling factor according to an exemplary embodiment of the present disclosure;

FIGS. 4e and 4f are illustrations of an experimentally measured and theoretically predicted influence of deformation on PIMs, according to an exemplary embodiment of the present disclosure;

FIGS. 5a-5d is an illustration of an application to imaging in the form of imaging of USAF 1951 resolution target performed for three lengths of fiber of 10 mm, according to an exemplary embodiment of the present disclosure,

FIGS. 5e-5h is an illustration of an application to imaging in the form of imaging of USAF 1951 resolution target performed for three lengths of fiber of 100 mm, according to an exemplary embodiment of the present disclosure;

FIGS. 5i-5l is an illustration of an application to imaging in the form of imaging of USAF 1951 resolution target performed for three lengths of fiber of 10 mm of 300 mm, according to an exemplary embodiment of the present disclosure, whereas the imaging with experimentally acquired transformation matrix is provided in FIGS. 5a, 5e, and 5i, three theoretically predicted transformation matrices corresponding to ideal step-index fiber are provided in FIGS. 5b, 5f, and 5(j), profile with correction for dopant diffusion are provided in FIGS. 5c, 5g, and 5k and profile with full correction are provided in FIGS. 5d, 5h, and 5l;

FIG. 6a is an illustration of imaging with deformed fiber with empirical TM of straight fiber, according to an exemplary embodiment of the present disclosure;

FIG. 6b is an illustration of imaging with TM after full DO correction, according to an exemplary embodiment of the present disclosure;

FIG. 6c is an illustration of imaging with TM with only diagonal components of DO applied, according to an exemplary embodiment of the present disclosure;

FIG. 6d is an illustration of imaging with TM with only phases of diagonal components of DO applied, according to an exemplary embodiment of the present disclosure; and

Figures S1 to S16 are supplementary figures referred herein, according to exemplary embodiments of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure as defined by the appended claims. The drawings are merely schematic and are not necessarily provided to scale.

### DESCRIPTION OF EXEMPLARY EMBODIMENTS

The present description provides a general description explaining various exemplary embodiments of the present disclosure, and an Addendum giving additional detail on calculations and methods.

Where reference is made to Supplementary Information and to Online Methods, these can be found at http://www.nature.com/nphoton/journal/v9/n8/full/nphoton.2015.112.html. The Supplementary Information includes moving images which cannot be reproduced herein.

### General Description

### Identification of Propagation Invariant Modes

An experimental geometry according to an exemplary embodiment of the present disclosure, introduced in Online Methods, facilitates an exemplary measurement of the TM in the representation of diffraction limited focal points (FP) sometimes also called “delta peaks”, which from the experimental perspective represents the most convenient choice. The input FPs (at the proximal end of the fiber) can be generated using a spatial light modulator that simply steers a focused laser beam into a required location at the input fiber facet. The output (distal) facet is imaged on a CCD chip and FPs are acquired from values of individual pixels.

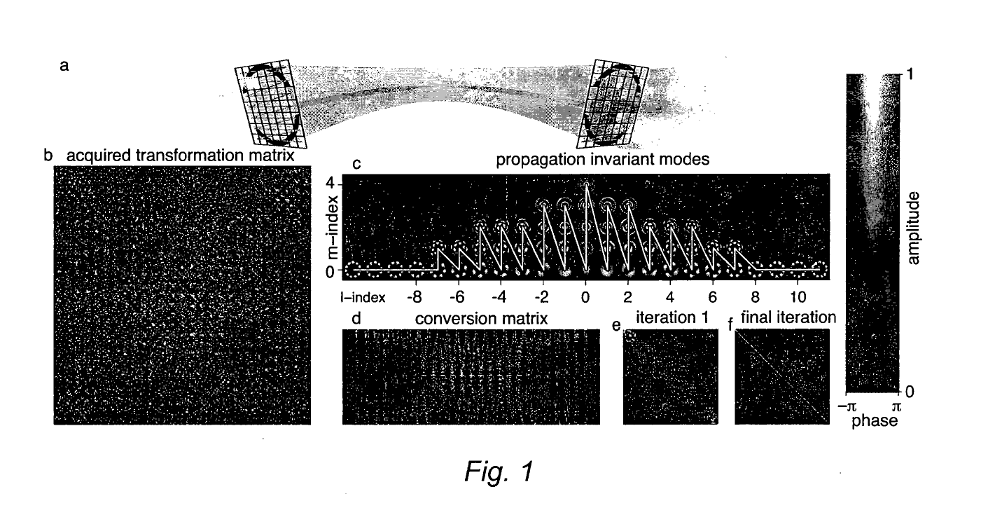

The chosen set of FPs is arranged across an orthogonal grid as shown in FIG. 1a and ordered as indicated by the red line. The experimentally measured transformation matrix M for a 10 mm long fiber segment is shown in FIG. 1b. Each row of M represents amplitudes and phases of all output FPs for a single input FP mode sent into the fiber. Due to space constraints, here, as well as in Figures the basis of modes for the TMs shown has been reduced to ⅓ of the full dimension. The complete transformation matrices are presented in Supplementary Figures S5-S7.

Following the TM acquisition, it is possible to numerically emulate the optical fiber as an optical system and predict the outcome of any optical field being sent into the fiber and thus validate the correctness of any theoretical prediction.

The simplest form of theoretical description (scalar and paraxial approach reviewed in Supplementary Methods S1) predicts the existence of linearly polarized (LP) modes that do not change their field distribution during propagation through the fiber. A series of such propagation invariant modes (PIMs), also known as eigenvectors of propagation operators or Eigen modes, are shown in FIG. 1c. Again due to space constraints, PIMs of a fiber are shown having many fewer modes. PIMs are defined by a pair of indices m and l. Index l refers to orbital angular momentum of a given mode with magnitude equal to lℏ/photon [see, e.g., Ref. 25].

Whether such modes would remain unchanged after travelling through the real fiber can now be tested using the experimentally measured TM: Each of these theoretically predicted PIMs can be constructed as a superposition of input FPs. Such a vector can be then virtually sent into the fiber which is implemented by its matrix multiplication with the TM. The resulting output vector of FPs should contain the identical PIM, differing only by a phase constant. Carrying out such operation for all modes simultaneously is mathematically equivalent to converting the experimentally measured M into the representation of PIMs. This can be achieved by constructing a conversion matrix T shown in FIG. 1d in which each line represents a single theoretically predicted PIM expressed as a superposition of input FPs. PIMs in T are ordered as indicated by the white line in FIG. 1c. If the theoretically predicted PIMs are the true eigenvectors of the experimentally measured transformation matrix M, its conversion into the representation of PIMs should result in purely diagonal matrix, indicating that each input mode was perfectly conserved.

The converted transformation matrix \acute{M}₀=TMT † is shown in FIG. 1e. Apparently \acute{M}₀ is not diagonal, which might lead to the conclusion that the optical fiber does not follow the theoretical model. However, off-diagonal components can also appear due to even a very small misalignment of the fiber. The misalignment space of the degrees of freedom is very large: 3-D position, two tilts and one defocus, each on both sides of the fiber. Moreover, these 12 degrees of freedom are intrinsically intertwined with uncertainty in the radius of the fiber core (a) and the value of numerical aperture (NA). An optimization procedure according to an exemplary embodiment of the present disclosure can be provided as described in Online Methods (source is available in online repository [Ref. 26]) that simultaneously corrects the TM for alignment imperfections and adjusts the values of a and NA. The optimized result \acute{M}_{final}, shown in FIG. 1f, carries 93% of optical power on the main diagonal showing an excellent match between the scalar theoretical prediction and the corrected experimental data.

### Polarisation Coupling of Modes

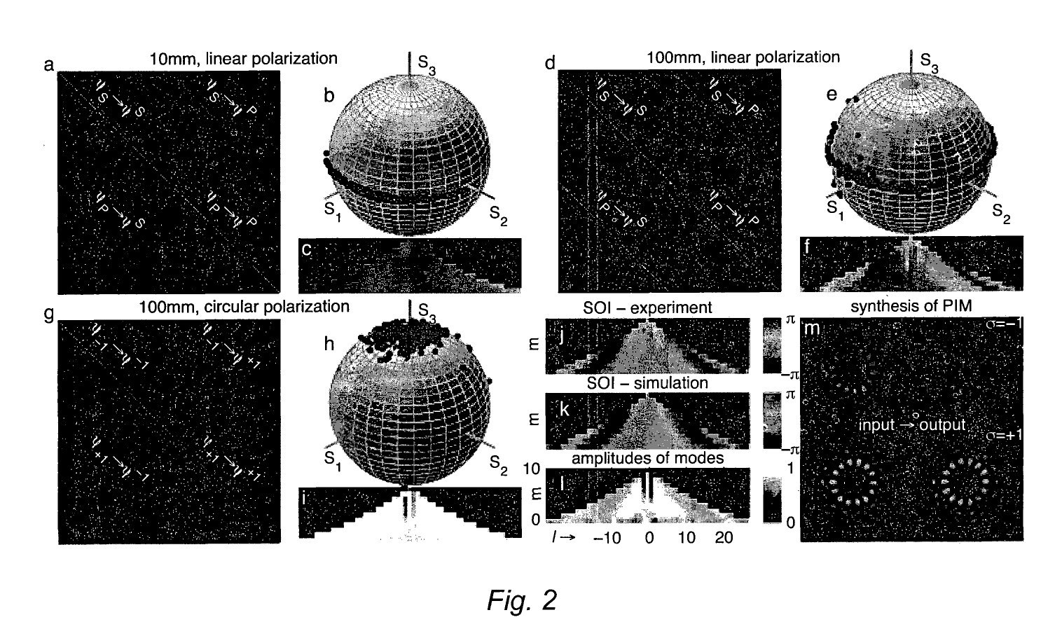

Each mode can be defined in two orthogonal polarization states and only when both are taken into the consideration can the TM be considered complete. Online Methods explains how it is possible to control the polarization in the exemplary geometry in order to take such complete measurements of TM. After the optimization and conversion into PIMs, such a complete TM will now have four quadrants, those containing the main diagonal indicate that the polarization of a given mode was conserved, while the remaining ones indicate mutual coupling between polarization states. The optimized TM with input PIMs defined by two orthogonal linear polarization states for the 10 mm long fiber is presented in FIG. 2a (see Supplementary Figures S7-S10 for complete data sets).

Coupling between polarization states is clearly present but relatively weak. The change of polarization state of individual LP PIMs can be efficiently visualized on the Poincare sphere as shown in FIG. 2b. It is seen that the polarizations of all modes remain linear but their orientation is rotated by up to 45° (which corresponds to a shift of 90° along the equator on the Poincare sphere). The same data are visualized by placing the polarization states of output PIMs into the shape of the 1-m pyramid as defined in FIG. 1c. The color defining the polarization state corresponds to the color of the Poincare sphere in FIG. 2b.

Equivalent measurements were taken for the 100 mm long fiber (see FIGS. 2d-f). Once again, output polarization remaining linear (apart from ‘misbehaving’ modes of l=±1 discussed later) can be seen, but this time the rotation of polarization is much stronger. Although this effect remains highly ordered, the observed polarization change proves that the LP PIMs can no longer be considered truly propagation-invariant. To account for this effect, it is possible to enhance the theoretical description to the fully vectorial model (presented in Supplementary Methods S1.1). This advanced description showed that only circularly polarized (CP) PIMs remain unaffected by propagation through the fiber. Coincidentally, CP PIMs have almost identical distribution of the field amplitude as LP PIMs which considerably simplifies their modelling.

The experimental study using circularly polarized modes propagating through a 100 mm long segment of fiber is summarized in FIGS. 2g-i. As expected, with these CP PIMs, transitions far from the original polarization state are not seen. The CP PIMs thus indeed represent propagation-invariant modes as predicted by an exemplary vectorial theoretical model. Interestingly, there is a broken symmetry between the modes having the same l and m indices but opposite circular polarization state(spin). Their optical fields are no longer symmetric as the wavefront helicity and spin are orientated the same way in one case but opposite in the other. The vectorial description predicts that the degeneracy in such pairs of modes is removed and in consequence they do not propagate with the same phase velocity [4,27]. This effect is well known in quantum optics as spin-orbit interaction (SOI). Such behavior can be very precisely identified in exemplary experimental data (see FIG. 2j) and also predicted by an exemplary theoretical model (see FIG. 2k).

FIG. 2l shows amplitudes of the output PIMs (diagonal components of TM in FIG. 2g). The most dominant losses are seen in modes of l=±1 which, as explained in Supplementary Methods S1.1, is caused by highly exceptional behavior of these modes, for which the CP PIMs-based model is not valid. To conclusively confirm the correctness of these findings exemplary results have been tested in an exemplary experimental geometry, taking into account all the detected alignment imperfections and experimentally synthesized the full orthogonal set of CP PIMs (see Online Methods for more details).

The PIMs have been recorded in both circular polarization states prior to entering the fiber as well as after leaving the fiber. One example showing a superposition of two such modes with the same m but opposite l indices is shown in FIG. 2m. The full sets of PIMs for the 10 mm and the 100 mm long fiber segments are presented in Supplementary Media SM2-SM5).

### Examination of Optical Phases

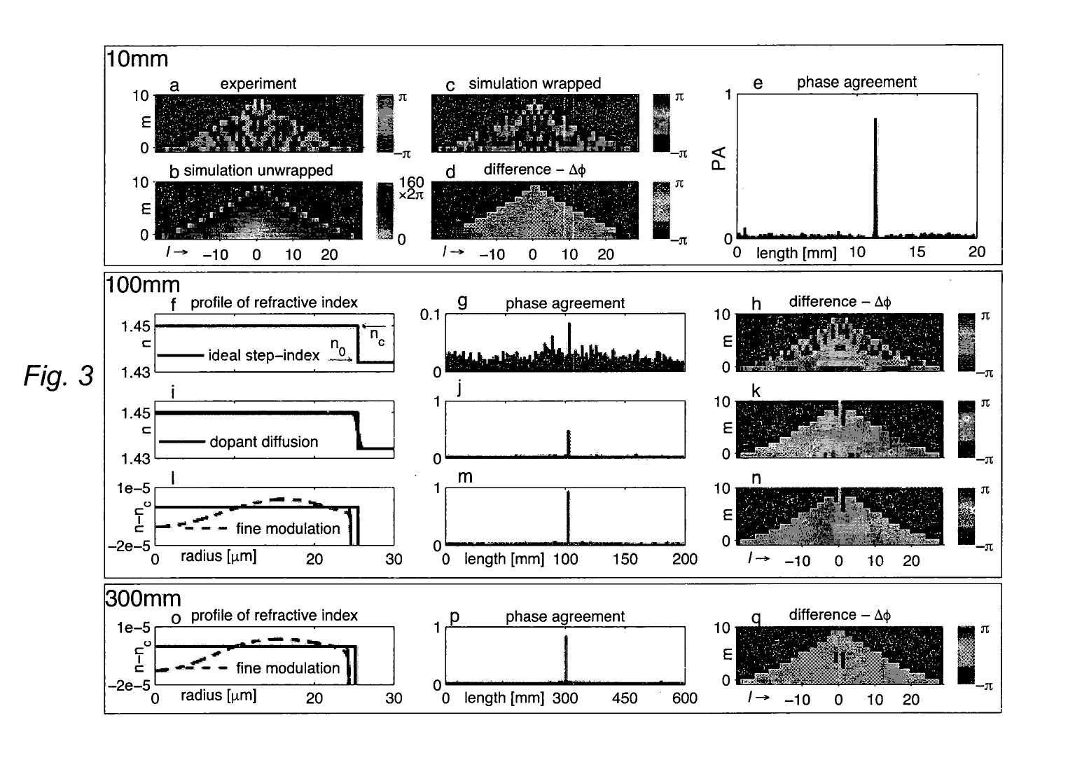

Evaluation of the ability to predict the optical phases of PIMs is of paramount importance to this study and conclusive in answering whether theoretically predicted TMs could be used for imaging. Phases of CP PIMS measured in the 10 mm long fiber segment are shown in FIG. 3a. Since the phases are wrapped within an interval of h−π,π], apart from mirror symmetry, (visible due to negligible contribution of SOI at this length) no ordered behavior is immediately apparent. The simulation for phases of PIMs using an exemplary numerical model is shown first unwrapped in FIG. 3b and then also wrapped in FIG. 3c. The difference between the simulation and the experiment is shown in FIG. 3d. This very good agreement only occurs if the length of the fiber is known with a very high precision (in the order of units of μm). The fiber length has been determined by seeking the highest value of the quantity referred to as total phase agreement (PA):

$${PA = \frac{1}{N} {\sum }_{j = 1}^{N} {e}^{i \cdot Δ∅ j} ]}^{2}$$

where N is the number of PIMs and Δφ j is the phase difference between the experimentally measured and theoretically predicted phases of j-th PIM. This quantity equals 1 for perfect agreement. PA as a function of assumed fiber length is plotted in FIG. 3e. Its peak value of 83% is very satisfactory given that the propagation constants of PIMs have been matched with a relative accuracy better than 10⁻⁵ Moreover, it is clearly seen that the deviations are not random (noisy) but rather form a smooth surface (FIG. 3d).

Repeating the same experiment with the 100 mm long fiber results in the PA peaking around the expected value of fiber length (FIG. 3g), but the PA peak value has decreased dramatically. The difference between the experimental and the theoretical phases is shown in FIG. 3h, clearly demonstrating that the aberration seen in FIG. 3d has grown proportionally with fiber length. This effect could not be explained by any aberration of an exemplary optical system according to an exemplary embodiment of the present disclosure. It is thus likely that the observed phase differences can be caused by deviations of the refractive index from the ideal step-index profile shown in FIG. 3f, originating e.g. from the diffusion of dopant material between core and cladding [28,29] (FIG. 3i).

To quantify this deviation, perturbation calculus has been employed as explained in Online Methods. The diffusion is commonly quantified by diffusion length d which became an additional free parameter in an exemplary optimization procedure according to an exemplary embodiment of the present disclosure (see Online Methods). With this exemplary model taking diffusion into account the PA was substantially enhanced (FIG. 3j) but still could not fully explain the observed deviation demonstrated in FIG. 3k. Therefore, a search was performed for further deviations of refractive index within the fiber core and using perturbation calculus, their description has been arrived at using zero-order Zernike polynomials (Z⁰₄(r/a), Z⁰₆(r/a), Z⁰₈(r/a), . . . ) finding that only the first two of this series are required to entirely explain the observed phase deviations.

Even with such minuscule modifications in the refractive index profile (shown in FIG. 3l) the PA has been enhanced beyond the value of 0.95 (FIG. 3m). The difference between the experimental and the theoretical phases of PIMs is shown in FIG. 3n. Further extending the length of the fiber to 300 mm it was found that for satisfactory agreement shown in FIGS. 3o-q, it was preferred to supplement one more free parameter of fine modulation.

### Transformation Matrix for Deformed Fibers

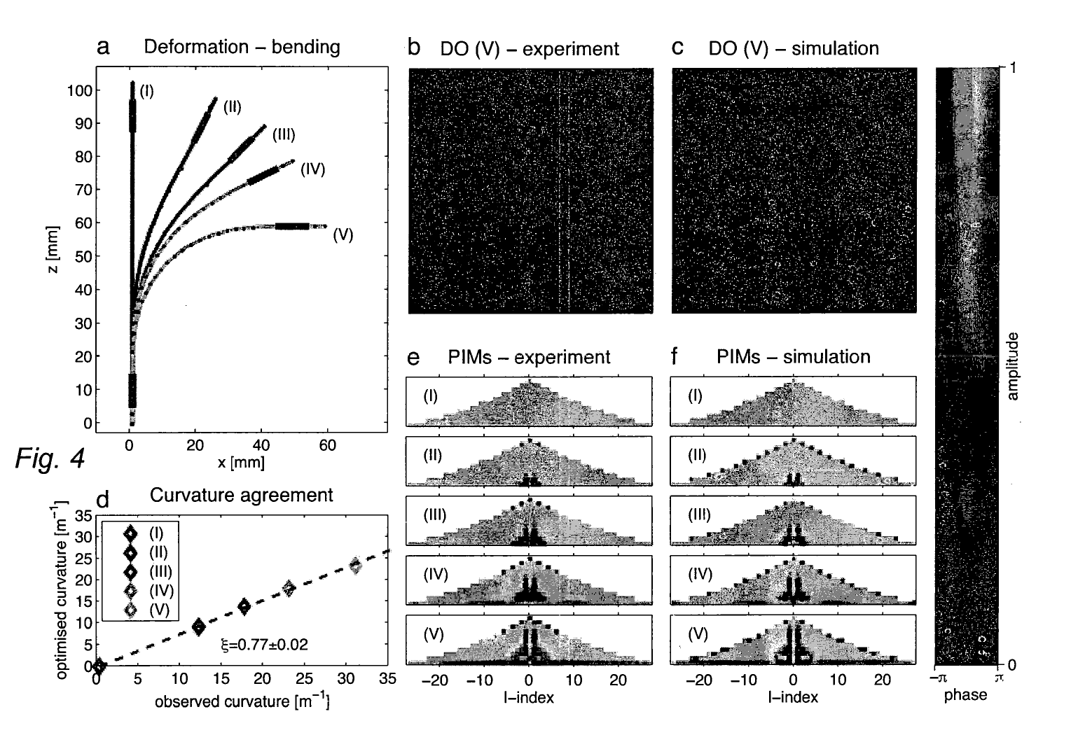

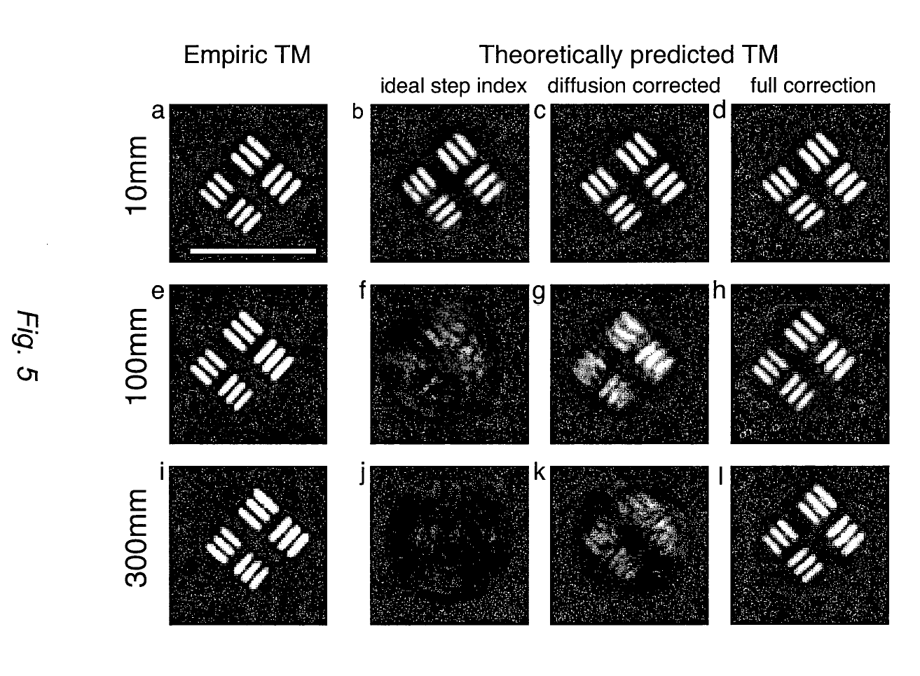

An exemplary experimental geometry was designed to allow bending of optical fiber with curvatures reaching the long-term damage threshold given by the manufacturer. TMs have been measured for several different fiber geometries by translating and rotating the output end of the fiber which was monitored with high precision. Using this information, the shape of the fiber has been constructed numerically by minimizing its elastic energy. These shapes are represented in FIG. 4a by solid lines and complemented by the actual layout of the fiber (marked by black dots) obtained from camera images. The changes introduced to TM by such deformations can be best characterized by a deformation operator (DO), which describes the transition of the straight fiber TM (\acute{M}₅) to the TM of the bent fiber (\acute{M}_{b}):

(\acute{M}_{b})=\hat{D}\acute{M}₅

An example of an experimentally measured DO (in the representation of PIMs) is shown in FIG. 4b (only one polarization component, for full DO see Supplementary Figure S12), which corresponds to the largest curvature (V) introduced to the fiber. It is clearly seen that even for a curvature reaching the damage threshold, DO remains highly diagonal thus indicating that majority of PIMs were very well conserved. The main effect of deformation is therefore only a small relative phase shift of the PIMs. Diagonal components of DO (influence on PIMs) for all fiber deformations are presented in FIG. 4e. Apparently, PIMs with low 1 and m indices are the most vulnerable to such deformations.

An exemplary theoretical description of bent fibers is detailed in Online Methods. This analytical model can directly handle only fiber segments with uniform curvature. Therefore, to model exemplary experimental conditions as authentically as possible, it is possible to provide the corresponding theoretical TM from 300 segments, each with constant curvature corresponding to the minimal elastic energy fiber layout (FIG. 4a). The results of the simulation indicated effects of the same kind as observed experimentally, but noticeably stronger. Therefore, a search was performed numerically for an empirical scaling factor with which a reduction of the curvature of the fiber was performed in an exemplary model according to an exemplary embodiment of the present disclosure in order to obtain the optimal agreement with the experiment. For most or all exemplary fiber deformations (II)-(V) the scaling factor found was very similar (see FIG. 4d) and its value can be estimated to be 0.77±0.02. Further theoretical investigation revealed that this effect could be caused by linear variation of refractive index with respect to material density that changes under the influence of deformation-induced stress.

This leads to exactly the same effect as fiber bending, but with opposite action. Assuming that (n−1) is directly proportional to the material density [30] the scaling factor can be expressed as

$$ξ = 1 - \frac{n - 1}{n} ( 1 - 2 σ )$$

where σ is Poisson's ratio (see Online Methods). With a value of σ=0.17, which is a typical material constant of fused silica given by many manufacturers, a value of ξ=0.79 was reached which is in perfect agreement with an exemplary experiment. Theoretically predicted DO corresponding to fiber deformation (V) (with the empirical scaling factor applied) is shown in FIG. 4c (see Supplementary Figure S13 for all polarization components), and diagonal components for theoretically predicted DOs are depicted in FIG. 4f.

Importantly, the theoretical model predicts that the DO does not change if the plane in which the deformed fiber lies is oriented differently. This was confirmed by extending this study into the third dimension, which is presented in Supplementary Results SR1.

### Application to Imaging

Being able to predict the correct spatial distribution of the optical fields of PIMs together with their correct phases after propagating through the fiber allows a construction of a transformation matrix of a multimode fiber in any representation of modes, purely based on the grounds of theoretical modelling. For imaging purposes the representation of FPs is the natural choice. In this representation, each column of the TM indicates what superposition of input FPs, is advantageous to provide in order to get a single diffraction limited FP at the distal end of the fiber. In consequence, it is possible to design a corresponding holographic modulation for an exemplary SLM (taking into account all detected misalignment imperfections) in order to synthesize such output FP experimentally. Using various forms of theoretically predicted TMs, a set of FPs have been synthesized across an orthogonal grid of 75×75 different positions, which have been sequentially lit-up by the SLM to efficiently raster-scan the object during image acquisition. Each pixel value of the resultant image was obtained by measuring the total optical power transmitted through the object while exposed to a single FP. More details on this approach, as well as the demonstration of proximal end imaging, can be found in the Supplementary results SR2 and the Supplementary Media SM7.

For an exemplary demonstration of imaging a negative USAF 1951 resolution target was selected as the imaging object, which was placed in a close proximity to the distal end of the fiber. In Supplementary Results SR3, it is shown that imaging is not restricted to the proximity of the fiber facet but with the use of a free-space propagation operator the image plane can be easily shifted to an arbitrary distance behind the fiber facet. An exemplary evaluation can start with the 10 mm long fiber. FIG. 5a shows traditional imaging with experimentally measured TM [7-9, 18]. The imaging performance is compared with those obtained while using three different theoretically predicted TMs that correspond to the ideal step-index profile (FIG. 5b), profile with diffusion of dopant material (FIG. 5c) and finally the fully corrected profile (FIG. 5d).

The imaging was successful in all cases, and a small aberration due to refractive index profile imperfections (FIG. 3d) has minimal influence on imaging quality. Equivalent tests were performed for 100 mm-long fiber (FIG. 5e-h) and 300 mm-long fiber (FIG. 5i-1). Employing the theoretically predicted TM of ideal step-index fiber at these length scales entirely fails to produce a recognizable image, which clearly demonstrates the importance of the phase corrections studied earlier.

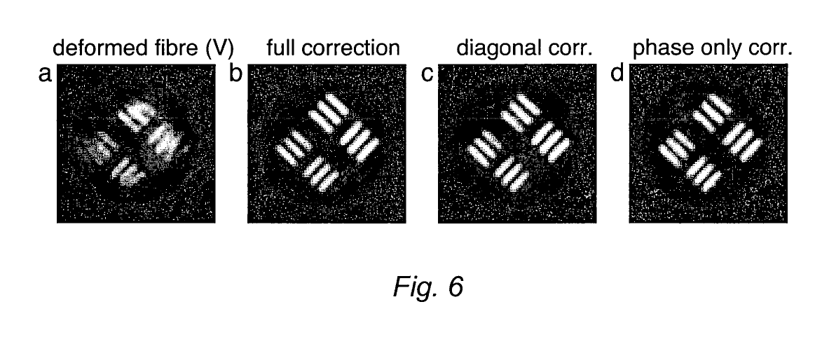

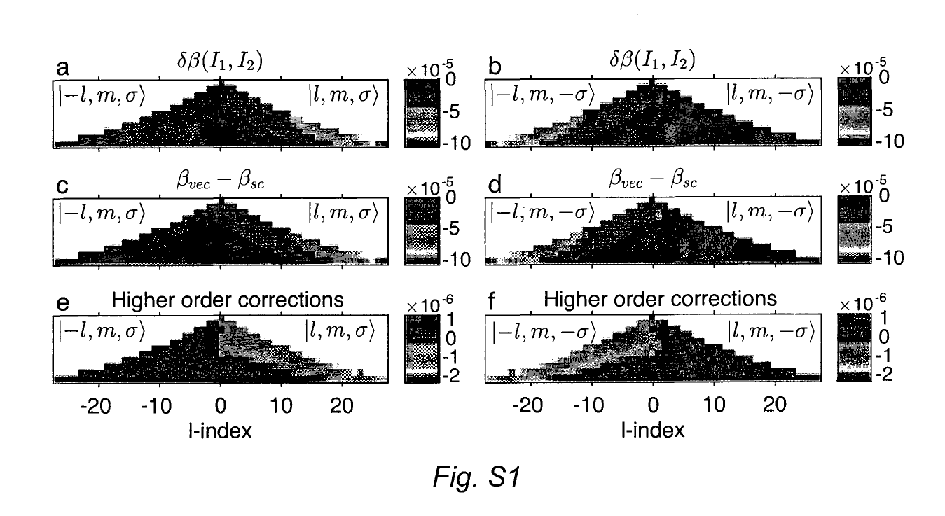

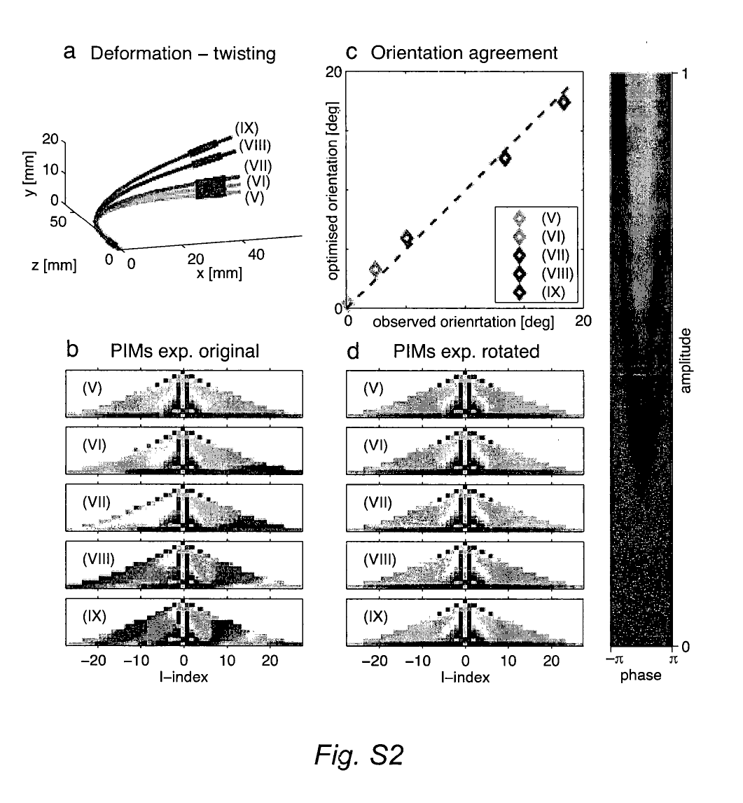

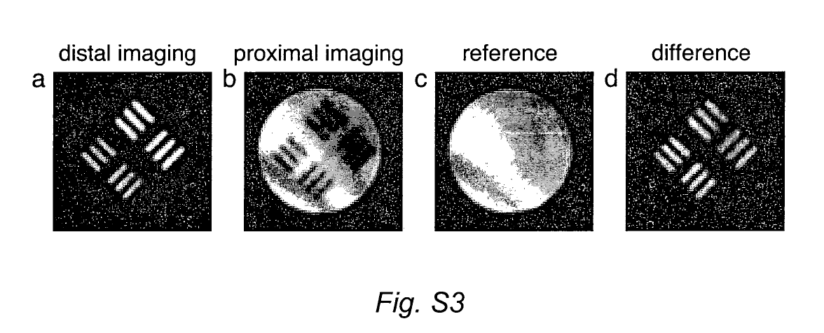

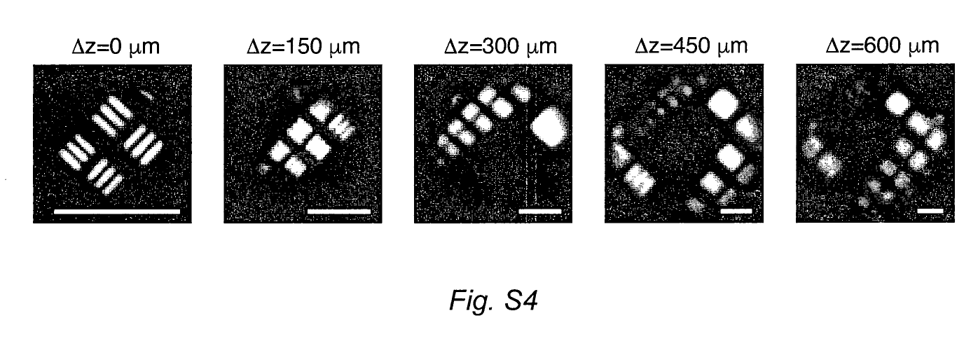

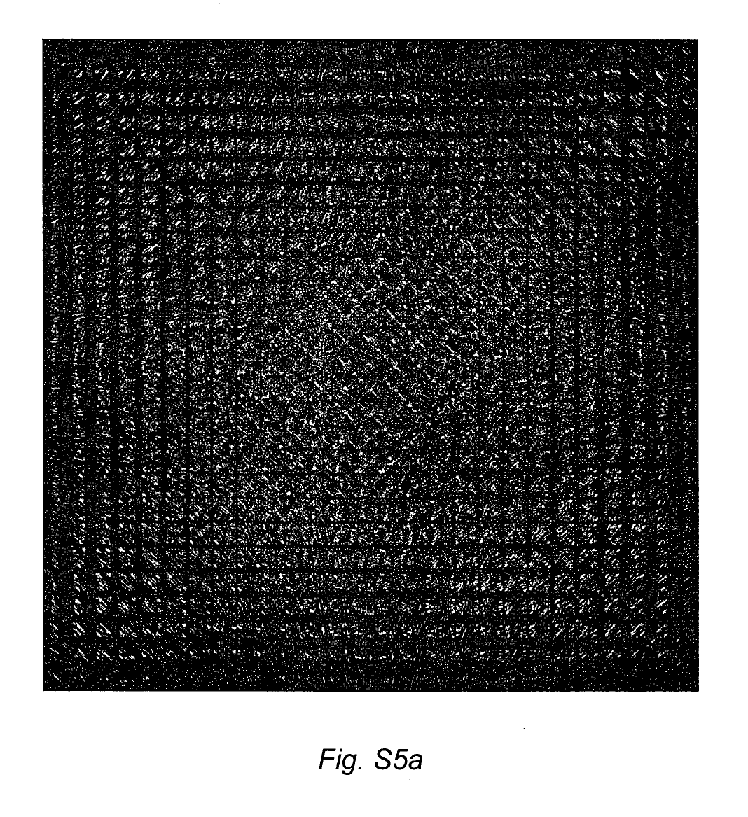

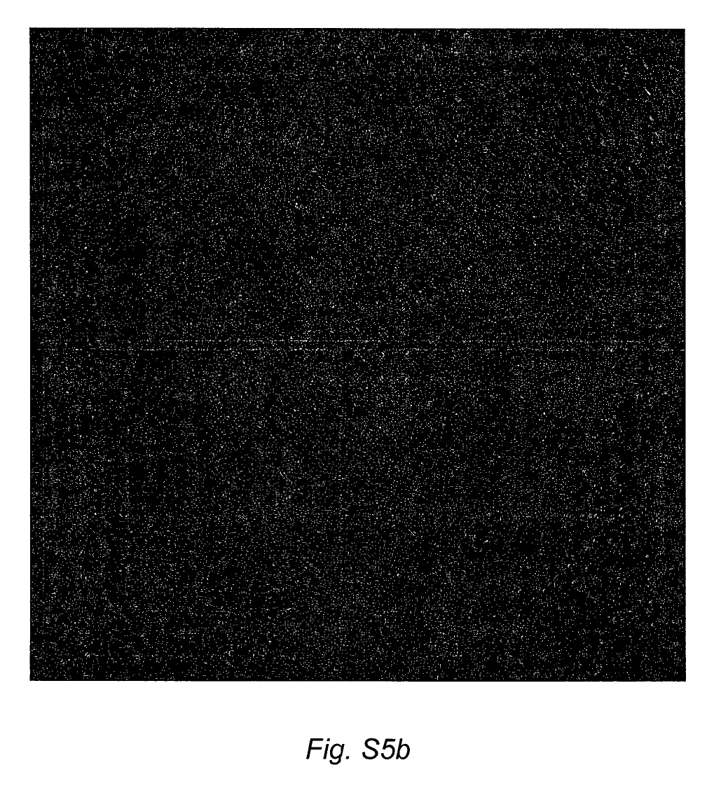

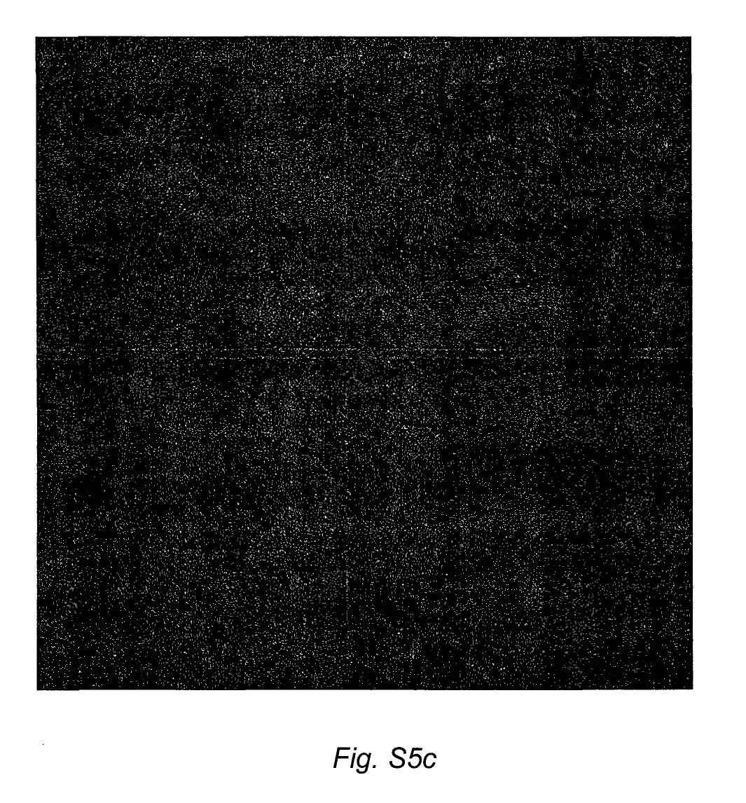

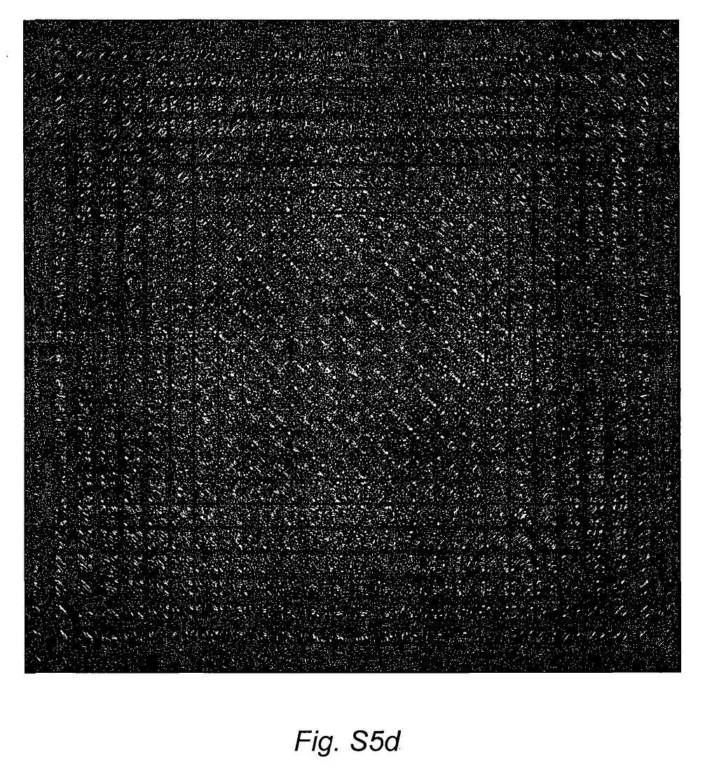

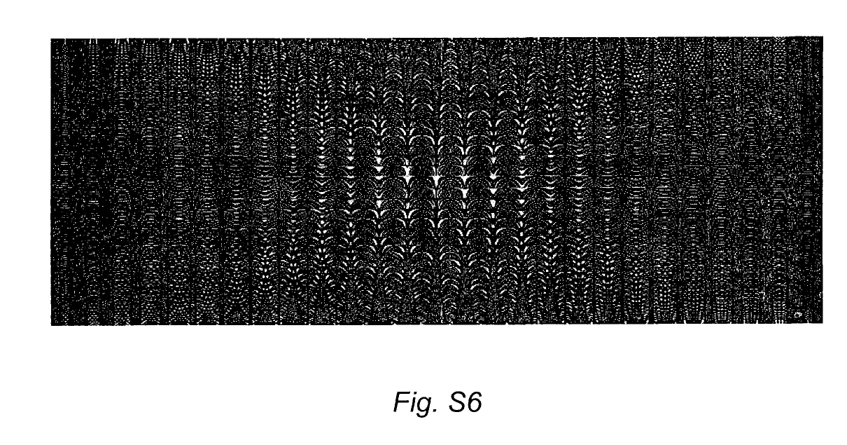

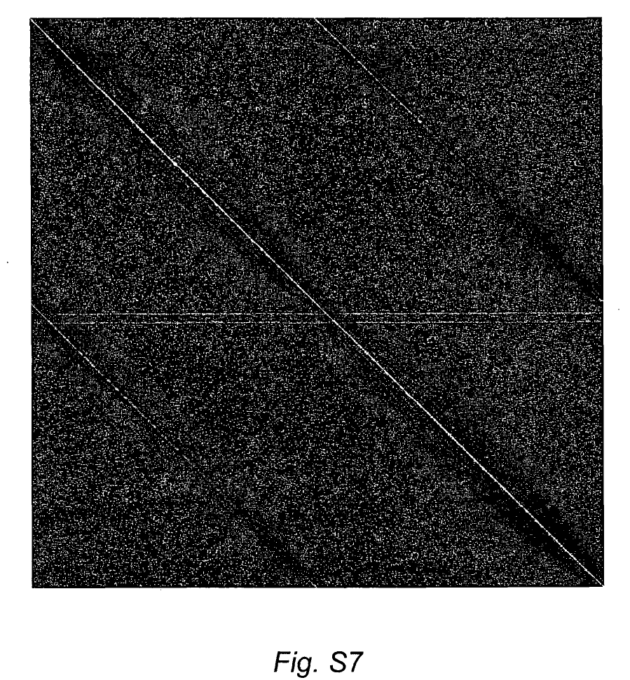

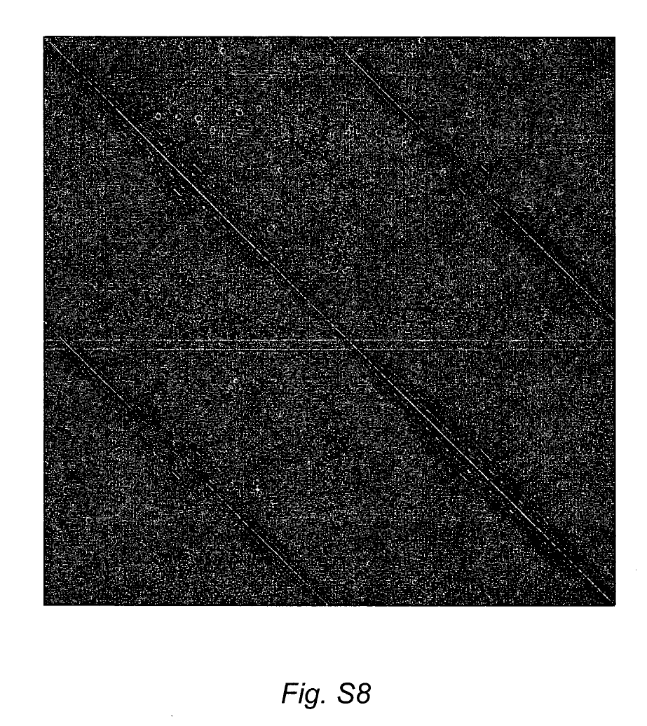

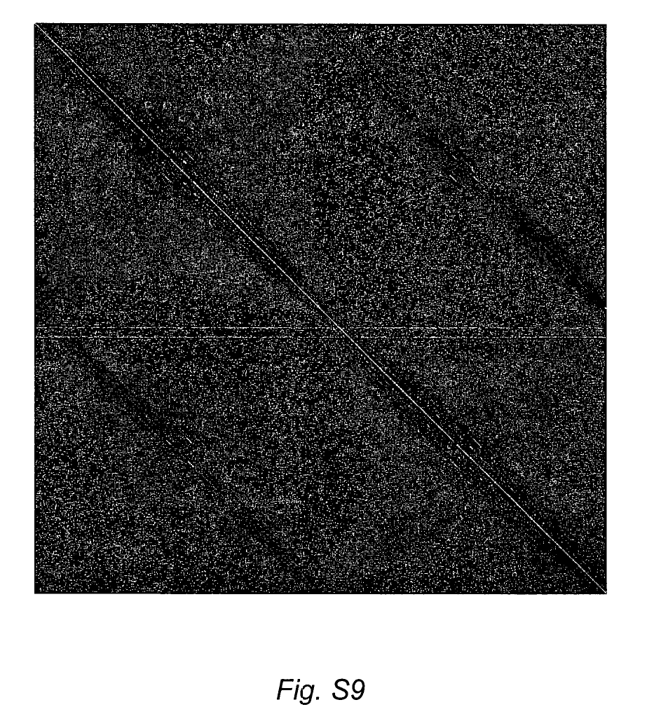

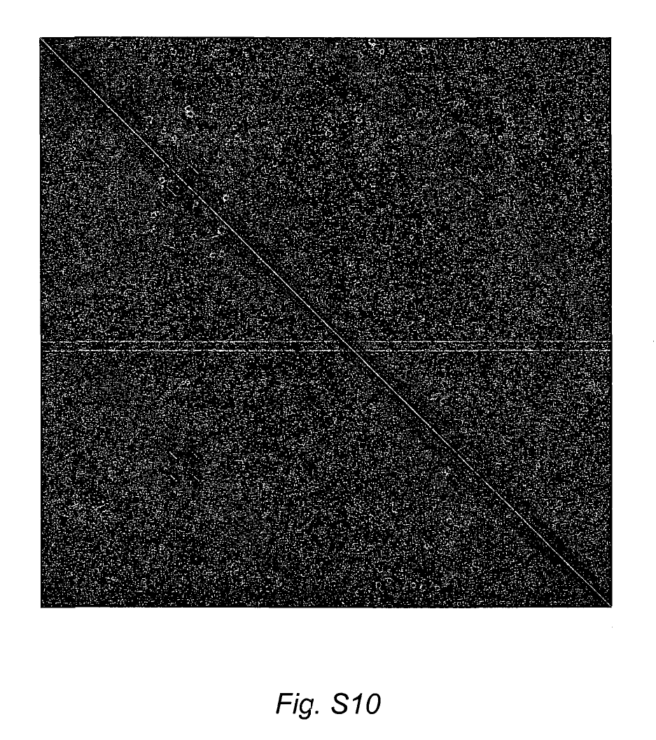

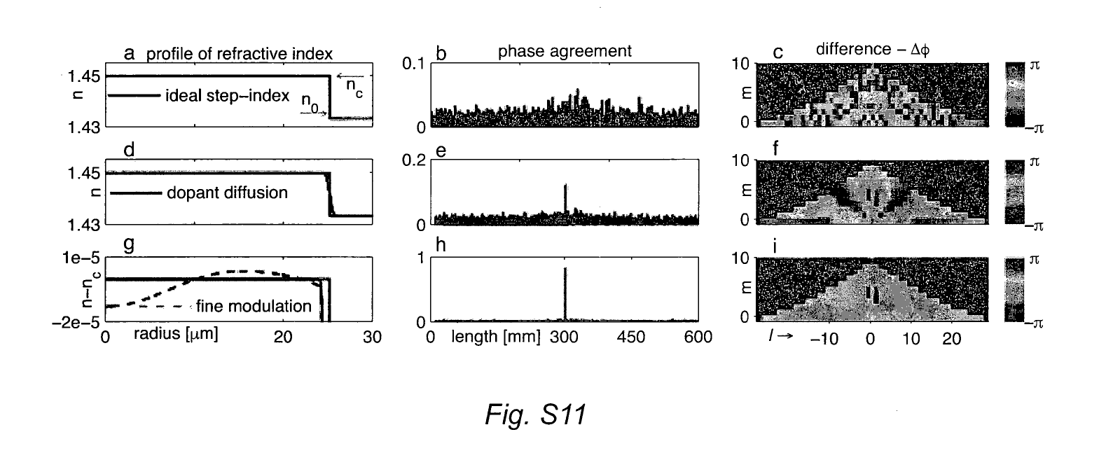

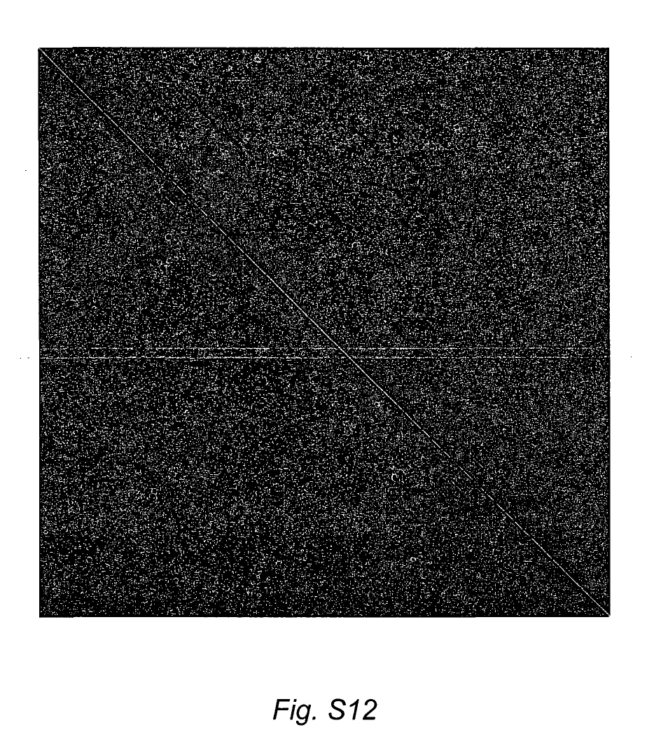

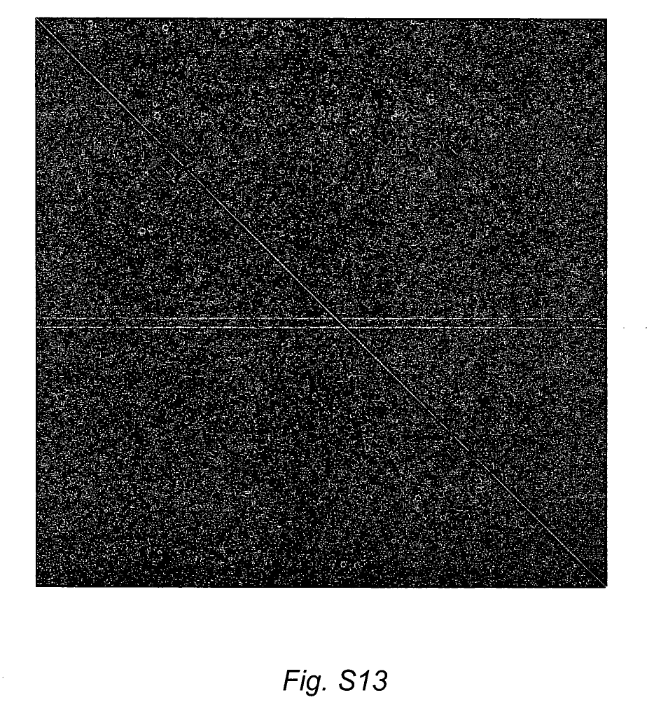

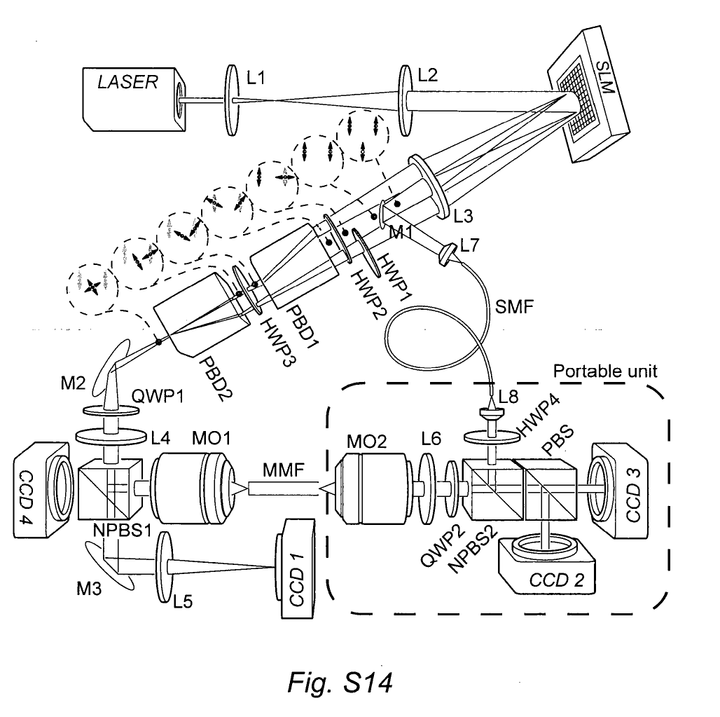

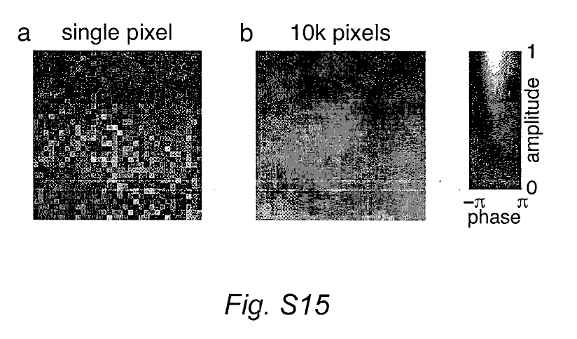

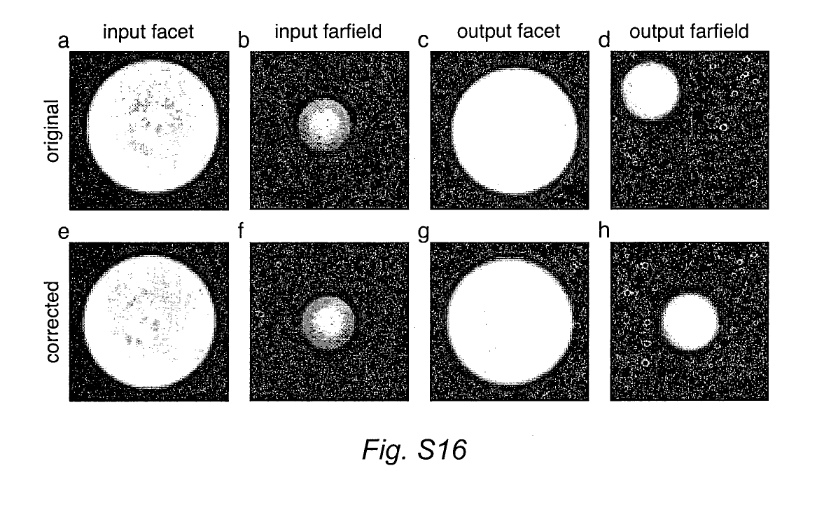

Much better but still heavily impaired imaging can be obtained after taking diffusion effect in refractive index profile into account (FIG. 5g, k). But only after implementing additional correction for the fine modulation of refractive index (FIG. 5h,l) does the imaging quality approaches that for the case of an experimentally measured TM (FIG. 5e, i). The influence of bending is demonstrated in FIG. 6a, where the TM measured on a straight segment of fiber was used for imaging after the fiber was bent as illustrated by deformation (V) in FIG. 4a. Results obtained after applying appropriate theoretically predicted DO (FIG. 4c) are shown in FIG. 6b. Further DO was tested with all off-diagonal components set to zero (see FIG. 6c) and additionally also set absolute values of diagonal components to unity (see FIG. 6d). Both of these simplifications exhibit negligible effects on the imaging performance, thus confirming that DOs are highly diagonal and therefore almost perfectly commuting with one another. This will immensely simplify predicting DOs of more complex deformations since the order in which individual bends follow along the fiber won't play an important role.

### Discussion

It was demonstrated that MMFs are highly predictable optical systems. Exemplary methods can be provided to measure and analyze TMs of real-life MMFs as well as a complex theoretical framework to describe the light-transport processes within, taking into account several important deviations of the refractive index profile and fiber curvature. No significant randomizing processes in 300 mm long fiber segments have been identified, and based on the behavior observed it is very unlikely that highly ordered light propagation would be obstructed in the length scale of even several meters.

From exemplary results, it is clear which modes are the most vulnerable to fiber deformations and in turn which are the most immune. This is of crucial importance not only for endoscopy but also for many other disciplines including telecommunications (mode-division multiplexing).

It was found that the strength of deformation-induced TM changes can be tuned by selection of refractive index and Poisson's ratio. This may bring an exciting new possibility to design fibers featuring suppressed bending effects (minimizing value of ξ), however the ultimate goal of designing fibers with ξ=0, for which the light transport processes are entirely invariant to fiber deformation would require either negative refractive index or negative Poisson ratio, both very difficult to achieve experimentally.

For example, the latter can possibly be approached by providing a highly anisotropic sleeve around the fiber. The startling agreement of theoretical predictions with experimental reality allowed a performance of imaging using theoretically predicted TMs in straight and curved fiber segments sufficiently long for many practical applications in life sciences, medicine and other disciplines. These new possibilities bring a step-change for this technology by eliminating the most critical drawbacks related to the requirement for empirically measured TMs as well as lack of flexibility. There can be currently no fundamental problems standing in a way of further fast development of this exciting technology, and with sufficiently sophisticated engineering, it is possible to see a multitude of exciting applications such as observations of single or multiple neurons in unrestrained and awake animal models.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety.

In addition, it should be mentioned that the terms “comprising” and “having” do not exclude any other elements or steps, and “a” or “an” does not rule out more than one. It should further be pointed out that features or steps described with reference to one of the above embodiments may also be used in combination with other features or steps of other above-described embodiments. Reference numerals in the claims should not be treated as limiting.

### ADDENDUM

In this section, further exemplary details are provided on methods and experimental setups used in developing exemplary embodiment of the present disclosure, followed by a section on supplementary methods.

### Methods

### Calculating the Changes of Propagation Constants Due to Deviations in Refractive Index Profile

Light transport processes in multimode fibers are theoretically well understood and the necessary theoretical considerations are briefly reviewed in Supplementary Methods S1. In order to find corrections to the propagation constants arising from slight deviations of the refractive index profile, it is possible to use perturbation calculus with respect to the basic scalar theory. These corrections are then added to propagation constants calculated by the weak guidance approximation of the full vector model to obtain corrected propagation constants.

The refractive index in the ideal step fiber can be denoted by n(r) and the slightly modified index by n 0 (r). Starting from the scalar wave equation ΔΨ−(n/c)² ∂ₜ²Ψ=0 and separating the time and z-coordinate along the fiber as Ψ(r,ϕ,z,t)=ψ(r,ϕ)exp[i(βz−ωt)]), it is possible to arrive at the Helmholtz equation for the transversal part of the wave ψ(r,ϕ) in the step refractive index n(r):

[Δ_{⊥}+k₀²n²−β²]ψ(r,ϕ)=0, (3)

where Δ_{⊥} is the transversal part of the Laplacian. The solutions can be indexed by the angular index l (angular momentum, or topological charge) and radial index m as mentioned before. A similar equation holds for the perturbed mode functions ψ 0 (r,ϕ),

but with n replaced by n′ and β replaced by the perturbed propagation constants β′. Next, it is possible to write the square of the modified refractive index as n′² (r)=n² (r)+g(r), where g(r) is a small perturbation, express the mode functions ψ′ₗₘ as superpositions of the unperturbed mode functions ψₗₘ, and perform the standard perturbation calculation. In this way, it is possible to arrive at the following first-order correction to the propagation constant of the mode

$${ψ}^{′} lm \text{:} Δ {β}_{lm} = \frac{k {0}^{2}}{2 β lm} < {ψ}_{lm} \vert g \vert {ψ}_{lm} >= \frac{k {0}^{2}}{2 β lm} \frac{{\int }_{0}^{∞} [ {n}^{′2} ( aR ) - {n}^{2} ( aR ) ] {F}_{lm}^{2} ( R ) RdR}{{\int }_{0}^{∞} {F}^{2} ( R ) RdR} \qquad ( 4 )$$

For a given modified index n 0 (r), these corrections can be readily calculated by numerical integration. The polarization index σ of the mode does not influence the correction.

### Calculating the Changes to Transformation Matrix Due to Fiber Bending

Eigen modes of a bent fiber are different from those of a straight fiber. Taking into account the fact that in practice the radius of curvature is larger than the core radius by several orders of magnitude, one could be tempted to think that the two sets of modes will differ only slightly. This is not true, however, due to the very small index difference between the core and the cladding. In fact, the bending introduces effective index changes that are comparable to this index difference, and therefore perturbation theory would yield inaccurate results. Fortunately, one can still describe modes of the bent fiber approximately using a calculation that reminds of perturbation theory, as shown in the following.

Consider a short element of the fiber centered at the origin of Cartesian coordinates with the fiber axis oriented along the z axis. Suppose now that the fiber is bent in the xz plane with the radius of curvature ρ>>a with the center of curvature at the point (ρ,0,0). The local longitudinal wavenumber (along z axis) will no longer be constant across the fiber cross section but will depend on x as k_{z} (x)=(β′² (1+x/φ, where β′ is the value of the longitudinal wavenumber on the axis—the propagation constant. This yields the following equation for the mode in the xy plane:

$$[ {Δ}_{⊥} + {k}_{0}^{2} {n}^{2} - {{β}^{′ 2} ( 1 + \frac{x}{ρ} )}^{2} ] {ψ}^{′} = 0 \qquad ( 5 )$$

Next, express ψ′ as a superposition of the modes of the straight fiber, ψ′=Σᵢcᵢψᵢ (for simplicity, it is possible to replace the pair of indices l,m by a single index i), and substitute into Eq. (5). Using also Eq. (3), the following is obtained:

$${\sum }_{i} {c}_{i} [ {β}_{i}^{2} - {β}^{′ 2} ( 1 + \frac{2 x}{ρ} ) {ψ}_{I} = 0 \qquad ( 6 )$$

Multiplying this equation by, integrating over the xy plane, using the orthogonality of the functions ψᵢ, rearranging the terms slightly and interchanging the indices i and j, it is possible to get:

$${c}_{i} + \frac{2}{ρ} {\sum }_{j} \begin{matrix}{A}_{ij} {c}_{j} \\ \frac{1}{{β}_{i}^{2}}\end{matrix} = \frac{1}{{β}^{′ 2}} {c}_{i} \qquad ( 7 )$$

Here, the matrix element of the x coordinate is defined as

$${A}_{ij} ≡ 〈 ψ i \vert x \vert ψ j 〉 = \frac{{\int }_{0}^{∞} rdr {\int }_{0}^{2 π} d ϕ {ψ}_{i} ( r , ϕ ) rcos ϕ {ψ}_{j} ( r , ϕ )}{{N}_{i} {N}_{j}} \qquad ( 8 )$$

where

$${r , ϕ \vert {ψ}_{i} \vert 2 ]}^{1 / 2} rdr {\int }_{0}^{2 π} d ϕ = {\int }_{0}^{∞}$$

is the normalization constant of the i th mode. Equation (7) is in fact an eigenvalue problem for 1/β′². The eigenvectors (sequences of coefficients cᵢ) then determine the corresponding modes of the bent fiber. This equation can be further simplified by taking advantage of the fact that the propagation constants βᵢ are limited by the condition n_{cladding} k₀<βᵢ<n_{core} k₀ and therefore are all very close to n_{core} k₀. Making the substitutions βᵢ=n_{core} k₀+Δβᵢ and β′=n_{core} k₀+Δβ′, inserting into Eq. (7), neglecting the term containing the product Aᵢⱼ Δβᵢ and returning back from Δβᵢ, Δβ′ to βᵢ, β′, it is possible to finally obtain the equation

$${β}_{i} {c}_{i} - \frac{{n}_{core} {k}_{0}}{ρ} {\sum }_{j}^{ } {A}_{ij} {c}_{j} = {β}^{′} {c}_{i} \qquad ( 9 )$$

This equation shows that the propagation constants are eigenvalues of the matrix B with entries

$${B}_{ij} = {β}_{i} {\partial }_{ij} - ( \frac{{n}_{core} {k}_{0}}{ρ} ) 〈 ψ i \vert x \vert ψ j 〉 .$$

The advantage of Eq. (9) compared to Eq. (7) is that its eigenvalues are directly the new propagation constants. Therefore the evolution operator of the state along the fiber segment of length L is simply e iBL. Evolution along a fiber that is bent non-uniformly can be expressed as a product of such operators corresponding to sufficiently short fiber segments in which the curvature can be considered constant.

In the previous section, it was assumed that the refractive index profile of the deformed fiber remains identical to the original straight fiber. The fiber deformation, however, causes local density changes and consequently also refractive index changes, which influences light propagation. When the fiber is bent, its outer side becomes longer and the inner side becomes shorter. Such longitudinal changes of the length of infinitesimal fiber elements cause corresponding lateral changes of their width of opposite sign and smaller in magnitude by the factor of the Poisson ratio σ. In other words, the diagonal elements of the deformation tensor are related as εₓₓ=ε_{yy}=−σε_{zz}. The relative changes of the element volume and density are then Tr\hat{ε}=ε_{zz}(1−2σ) and −Tr\hat{ε}=−ε_{zz}(1−2σ), respectively, provided that the deformation is small. If it is assumed that the refractive index has the property that n−1 is proportional to the density, which seems to be reasonable for fused silica the fiber is made from, it is possible to obtain a modified refractive index n′=n−(n−1)ε_{zz}(1−2σ). Inserting this modified index n′ instead of n into Eq. (5) together with ε_{zz}=−x/ρ, it is possible to find after neglecting one insignificant term:

$$[ {Δ}_{⊥} + {k}_{0}^{2} {n}^{2} - {β}^{′ 2} ( 1 + \frac{2 x}{ρ} [ 1 - ( 1 - 2 σ ) \frac{n - 1}{1} ] ) ] {ψ}^{′} = 0$$

It can be seen that the resulting equation differs from Eq. (5) by the factor ξ=1−(1−2σ)(n−1)/n standing in front of the curvature 1/ρ. This means that the fiber behaves equally as if the index did not change but the bending were weaker by the factor of ξ. This also means that the effect of index change alone (due to fiber deformation) is of a similar character as the effect of the bending itself, just of opposite sign.

In general, the transverse deformation leads to a change of the shape of the cross section of the fiber core, which could also affect the modes. However, it is not hard to show that for the particular deformation in question, i.e., εₓₓ=ε_{yy}=−σε_{zz}=σx/ρ, the cross section remains circular (still with radius a) up to the first order in a/ρ; the deviation from the circular shape is of the second order in a/ρ and therefore completely negligible.

### The Experimental System

The exemplary studies have been accomplished using a step-index MMF with radius a=25.0±0.5 μm and numerical aperture (NA) 0.22±0.02 (these values were provided by the fiber supplier Thorlabs). An exemplary system is based on a standard digital holographic geometry in a Fourier regime where an SLM is imaged onto the back aperture of a microscope objective MO1 (20×, NA=0.25) by a 4-f system formed by lenses L3 and L4 (see Supplementary Figure S14 for a simplified scheme). The signal from the SLM (1064 nm) is sent to three different zones within this telescope simultaneously. One part is separated by mirror M1 and used as a reference signal during the acquisition of TM. The remaining two are sent into a system of half-wave plates HWP1-3 and polarizing beam displacers PBD1,2 to create and overlap two fields with orthogonal linear polarization states.

Even though this is sufficient for the generation of optical fields with an arbitrary spatial distribution of amplitude, phase and polarization, a quarter-wave plate QWP1 is inserted into the geometry to gain higher efficiency and reduce noise, since most of the experimental work requires circular polarization. Part of the signal sent to MO1 is separated by the non-polarizing beam splitter NPBS1 and imaged onto CCD1 to eliminate optical aberrations and measure SLM irradiance (detailed in the following section) and to monitor the field being sent into the MMF (the field recorded at CCD1 is a scaled copy of the field at the input facet of MMF). The optical signal leaving MMF is collected by microscope objective MO2 (same parameters as MO1) and focused by tube lens L6. Circularly polarized modes are converted to linearly polarized ones by HWP2 and individual polarization components are separated on polarizing beam splitter PBS and imaged on CCD2 and CCD3.

The reference signal is delivered to both CCD2 and CCD3 by single mode fiber SMF with collimator lenses L7 and L8 at each end. The reference optical pathway is merged with the imaging pathway before the polarization components are separated by NPBS2. The geometry facilitates a generation of any optical field allowed to propagate in the optical fiber and to observe how it is transformed by its transport through the fiber. Crucially, the geometry facilitates a generation and observation of all aspects of the input and output optical fields respectively, i.e. their intensity, phase and polarization. CCD4 was only employed in tests of proximal end imaging explained below in the section SR2.

### Wavefront Correction

All the experimental studies in this paper require beam control with extremely high fidelity, virtually free of optical aberrations. To eliminate aberrations in an exemplary complex optical system, it is possible to use a method developed in Ref [14]. The exemplary procedure described in such publication can efficiently manipulate phases of small segments of the SLM to gain the highest signal in the selected pixel of the CCD1, signifying optimal focusing. The quality of the resulting wavefront correction can be influenced by CCD noise and SLM flicker noise, both of which can be statistically averaged out by longer data collection. However, with increased duration of the procedure, it is possible to risk a strong influence of systematic drift. To overcome this trade off, it is possible to measure optical aberrations with large number of different pixels (10 000) simultaneously and combine the results. As pixels are organized across an orthogonal grid, each of these measurements carries a specific linear phase-modulation (equivalent of a prism) which can be predicted and subtracted from the data before averaging. The enhancement is demonstrated in Supplementary Figure S15.

### Measurement of Transformation Matrix

In an exemplary previous studies [see, e.g., Refs. 6 and 7], input modes have been defined for the transformation matrix as beamlets originating from series of SLM segments. One considerable problem of this approach is a relatively weak signal that is often significantly affected by various sources of scattered light. For the purposes of this study, it is possible to use a representation of optimally focused spots at the input facets of the MMF (as explained above). This is beneficial not only for gaining much stronger signals (the whole power reflected from SLM is utilized for analysis of every mode) but also for simpler comparison with theoretical prediction. During the TM measurement in this regime the SLM splits the optical power between two pathways—one is sent to the SMF which acts as a reference signal, and the other results in an FP input mode at a selected location of the input facet of MMF. Due to the series of polarization optical elements shown in Figure S14, each FP can be generated by two different SLM modulations of the signal, leading to generation of a pair of mutually orthogonal polarization states. Output FP modes are monitored on selected (grouped) pixels of CCD2 and CCD3, where the output fiber facet is imaged.

Their phases are established from interference with the reference signal delivered by a SMF. Employing the SLM to uniformly alter phase difference AO between the tested input mode and the reference field leads to a harmonic signal for each CCD pixel:

$$\begin{matrix}{I}_{CCD} = {\vert {F}_{m} \cdot {e}^{t \cdot Δ θ} + {F}_{ref} \vert}^{2} \\ {∅}_{m} + Δ θ \\ = {\vert {F}_{m} \vert}^{2} + {\vert {F}_{ref} \vert}^{2} + 2 \vert {F}_{m} \vert \vert {F}_{ref} \vert \cdot cos ) ,\end{matrix} \qquad ( 10 )$$

where Fm and Fref are the fields of the tested mode and the reference field, respectively. Typically, more than one period of 2π can be used in such measurement, e.g. Δθ=2π/4·[0, 1, . . . , 7].

Analyzing the detected signal, it is possible to immediately isolate the distribution of phase of the tested input mode φₘ across the output modes. From the measured harmonic signal, it is possible to also establish the magnitude of AC and DC components that based on equation (10) allow for recovery of the output mode amplitudes. This way the measurement is not affected by the Gaussian envelope and small spatial intensity nonuniformity of the reference signal (resulting from interference effects at various optical components of the reference pathway), which can significantly affect measurement of the TM. Similarly to Ref. [6], it is possible to use a feedback loop in order to eliminate drift between MMF optical pathway and the reference optical pathway. The initial measurement of the TM contains 1089 input modes and 5625 output modes. While the input modes are measured sequentially the output modes are measured simultaneously, and therefore they are favorably over sampled in order to reduce noise.

### Processing Raw Data

The data from direct measurement of the TM (M) are heavily affected by various sources of misalignment. Moreover, input and output modes are obtained with different sampling. Before such a TM can be used in comparison with theoretical prediction the data must be processed to address these issues. The amount of misalignment can roughly be estimated from total transmission profiles of the TM which in the ideal case (no misalignment) would be perfectly symmetric and focused on both sides of the optical system. These profiles are obtained by averaging absolute squares of either rows or columns of the TM and they signify position misalignment of the fiber end with respect to the optical pathway. Using a Fourier transform, it is possible to convert the measured TM into the representation of plane-waves which analogously provide transmission profiles, this time signifying tilts and defocus. The transmission profiles are shown in Supplementary Figure S16 (a-d).

All misalignment operators can be represented by phase-only linear or quadratic modulations of the modes or their Fourier spectra and combined into one matrix for input Aᵢₙ and one matrix for output Aₒᵤₜ of the fiber. The correction is then implemented by matrix multiplication of the TM from either side:\hat{M}=Aₒᵤₜ [symbol] A. The resulting pre-optimisation giving the best image symmetry and sharpness is presented in Supplementary Figure S16 (e-h).

Following this procedure the output modes are resampled using the scaling property of the Fourier transform in order to match the sampling of the input modes. Finally, redundant data (manifesting itself as dark boundaries in Supplementary Figure S16) are removed leading to a matrix with 729 input and 729 output modes presented in Figure S5. This operation is also achieved by matrix multiplication:

### Optimization Procedure

An exemplary optimization procedure gradually evolved over the course of this project to take into account a series of newly recognized factors. In the following, only the final one, optimized to study CP PIMs propagating through 100 mm long fiber segments is described. With the well-established theoretical description of light transport in MMFs [1] (reviewed in Supplementary Methods S1) and its modifications introduced above, it is possible to compute conversion matrix T that allows conversion of the measured TM into the representation of PIMs: \acute{M}=TMT †. Due to remaining misalignment imperfections and insufficient precision in estimation of fiber parameters this does not lead to satisfactory results and further optimization is necessary. While compensation for misalignment can be introduced by matrix multiplications of M, correction of fiber parameters requires calculation of new conversion matrix T at every iteration, which is time-consuming and \acute{M} does not have fixed size which requires more elaborate optimisation criteria to converge. Therefore these two parts of the optimization are decoupled. In each iteration (indexed by j) of the misalignment optimization procedure, it is possible to implement misalignment corrections to the experimentally measured TM before its conversion into PIMs: \acute{M}ⱼ=TCₒᵤₜMC T †. The quality metric that the algorithm optimises across the 12-dimensional space of free parameters is defined on the resulting matrix \acute{M}ⱼ as the fraction of the total optical power (absolute squares) carried by the TM's diagonal components, multiplied by PA (phase agreement introduced above).

During the optimization of fiber parameters (that directly influence the conversion matrix T) the quality metric defined on the resulting \acute{M}ⱼ is a combination of four factors. This time, it is possible to not use the total power ratio carried by diagonal components as this strongly favored small-sized matrices corresponding to low NA and smaller core diameters, which led to divergence of the optimization algorithm. Neither the total power of diagonal components proved itself to be a suitable criterion as it favored large-sized matrices corresponding to high NA and larger core diameters. The optimal power conversion was therefore achieved by reverse conversion of the \acute{M}ⱼ back into the space of diffraction limited points: Mᵣ^{j}=T^{†}\acute{M}ⱼT and comparison with the original experimentally measured one using a least squares approach: Σ(|Mᵣ^{j}|−|M|)². This value steeply falls while increasing both the NA and the diameter of fiber core but after passing the expected value it remains stationary. This was complemented by the introduction of a second criterion ensuring maximal uniformity of diagonal components. The standard deviation of diagonal components of \acute{M}ⱼ remains stationary until reaching the expected values and than rises steeply. Similarly, as in the previous case, it is possible to use PA as the third optimisation factor (PA⁻¹ as search is performed for minimum in this case). Finally, it is possible to determine that much faster convergence is ensured by minimizing the value of a fourth criterion which represents a total power of elements directly neighboring to the main diagonal. The combination of these four criteria features a sharp minimum in the multidimensional space of all fiber parameters: NA, core diameter, diffusion lengths, and further refractive index corrections as described above.

Both parts of the optimization procedure are cycled several times until a stationary point is reached. The result of the algorithm is the set of optimal fiber parameters, optimized \acute{M} and T and fine misalignment matrices Cᵢₙ and Cₒᵤₜ. The commented Matlab code for this part together with detailed instructions and samples of pre-optimized experimental data samples (M) is available for download from [26].

The whole optimization procedure is executed separately for polarization components of \tilde{M}

$$[ \begin{matrix}{\tilde{M}}_{- 1}^{- 1} & {\tilde{M}}_{- 1}^{+ 1} \\ {\tilde{M}}_{+ 1}^{- 1} & {\tilde{M}}_{+ 1}^{+ 1}\end{matrix} ] .$$

Optimal fiber parameters are sought in the first step of analyzing \tilde{M}₋₁⁻¹ together with misalignment factors. A record of this procedure is presented in Supplementary media SM1. This is followed by analysis of \tilde{M}₊₁⁺¹ where misalignment parameters as sought (light follows different optical pathway as shown in Figure S14) and for conversion into PIMs, it is possible to use fiber parameters obtained in the previous step. For conversion of components \tilde{M}₋₁⁺¹ and \tilde{M}₊₁⁻¹, all the misalignment parameters of the systems can be known from analysis of \tilde{M}₋₁⁻¹ and \tilde{M}₊₁⁺¹, therefore no further optimization is needed.

### Computing Complex Holographic Modulations

Exemplary LabView-based controlling system is designed to synthesize complex holographic modulations to be applied across the SLM. It uses the experimentally measured TM (\tilde{M}) to combine a series of input modes (in the representation of FPs) in order to achieve any output optical field leaving the optical fiber, with arbitrary distribution of amplitude, phase and polarization. This is achieved using a modified version [31] of the Gerchberg-Saxton algorithm [32].

### Synthesis of Holograms for Imaging

Since imaging is achieved by scanning a FP behind the output fiber facet, performing imaging with an experimentally measured TM is accomplished by sequential indexing of rows of \tilde{M} leading to synthesis of a single FP output mode at a time. For imaging with theoretically predicted transformation matrices \acute{M}ₜₕ, it is possible to utilize pairs of matrices A, B and C obtained during optimization of the data: \acute{M}ₜₕ=Aₒᵤₜ^{†}Bₒᵤₜ^{†}Cₒᵤₜ^{†}T^{†}\acute{M}ₜₕTC^{†}B^{†}A^{†}. Here \acute{M}ₜₕ represents any of the modifications introduced in the main text, including those for deformed fibers and axially shifted imaging planes.

### Generation of PIMs

Generation of individual PIMs uses the same procedure as described in the previous case. The only difference is in the transformation matrix that can be loaded into the controlling interface. Instead of the fully reversed conversion, it is possible to only convert the input modes as \tilde{M}ₜₕ^{PIM}=\acute{M}ₜₕTC^{†}B^{†}A^{†}. The matrix \tilde{M}ₜₕ^{PIM} is a hybrid transformation between the input, represented using FPs and the output represented by PIMs. The complete set of PIMs recorded is presented in Supplementary Media SM2-SM5.

### Supplementary Methods

### Theoretical Description of Light Propagation in Multimode Fibers

The most common description of light propagation in MMF is based on the assumption that the polarization state of the optical fields propagating through them remains unchanged. Such scalar and paraxial modelling based on the theory of weakly guiding modes leads to the identification of a set of orthogonal linearly polarized (LP) propagation-invariant modes (PIMs) with radial dependence described simply by splicing a Bessel function of the first kind and a modified Bessel function of the second kind defined across the fiber core and the cladding, respectively. The requirement of continuity of the function together with its first derivative leads to a set of discrete solutions (being indexed by letter m in this paper) for every order of the Bessel functions l. The intensities of the fields are azimuthally independent and their phase varies with the azimuthal coordinate ϕ as e^{ilϕ}. This simplified approach serves well to explain several important light transport processes, however linearly polarized light in an MMF with parameters such as those used in exemplary experiments will only retain its polarization state over distances of a few tens of millimeters. A rigorous vectorial modelling also predicts the existence of a set of PIMs; their polarization is however no longer uniform, with orientation periodically changing across the mode cross-section. Very fortunately, for the majority of the modes the theory predicts degeneracy in the values of propagation constants (axial components of the k vector). A linear combination of such degenerate modes therefore also leads to propagation-invariant optical fields that have an almost identical distribution of the field to the simplified scalar LP PIMs and uniform polarization across the mode cross-section, but the polarization state is circular. Due to these qualities, it is possible to choose this representation for an exemplary experimental study since it is much easier to generate circularly polarized (CP) modes than modes with spatially non-uniform distribution of polarization. The only exception to this are azimuthally and radially polarized modes sometimes termed as hedgehogs and bagels. While their superposition leads to modes with l=±1, here such degeneracy does not occur. In an exemplary model according to an exemplary embodiment of the present disclosure, they are approximated by circularly polarized modes with averaged propagation constants. Intensity of such modes is still azimuthally independent but their energy periodically oscillates between opposite polarization states, therefore they are no longer propagation invariant. As shown in FIG. 6, this insufficiency has a negligible influence on imaging performance.

The representation of discrete circularly polarized modes can be conveniently expressed using a quantum formalism describing each mode with the trio of integer quantum numbers l, m and σ. In this formalism, l and σ denote the amount of orbital and spin angular momentum, respectively, in the units of h per photon [25]. This representation is also very convenient to observe the effect of spin-orbit interaction. This effect, known from quantum physics, causes two modes with the same but nonzero l and opposite spin states σ=−1 and σ=1 to propagate with slightly different phase velocities.

The similarity of the vectorial CP modes with the scalar LP modes makes this representation very suitable for implementing corrections for deviations from the ideal step-index profile that can strongly influence the experimental observations. Again, the influence of these aberrations does not considerably affect the distribution of optical fields of the modes. The most pronounced effect is a small variation of propagation constants (relative deviations are in the order of 10⁻⁶) which can however significantly affect the output phases of the modes over distances of only a few tens of millimeters. As can be seen, these small deviations of propagation constants can be modelled sufficiently precisely and efficiently using scalar LP modes by employing perturbation calculus. An exemplary modelling technique can therefore be a hybrid solution employing exact vectorial CP modes with propagation constants being corrected for imperfections in the step-index profile.

### Vector Modes

CP PIMs constitute the simplest set of modal fields that take into account the vector character of light propagation. In a step-index profile circular fiber the transverse electric field components of CP PIMs can be expressed as:

Ψ_{l,m,σ}=(\hat{x}+iσŷ)F_{l,m}(R)exp(ilσ),β=β_{sc}+δβ_{l,±} (S1)

where R=r/a is a dimensionless radial parameter with r being the radial coordinate and a the radius of the fiber core. β are the propagation constants of the corresponding modes, and the polarization corrections can be denoted to scalar propagation constants β_{sc} by δβ_{l,+} for l,σ with equal signs and by δβ_{l,-} for l,σ with opposite signs. \hat{x} and ŷ are unit Cartesian coordinate vectors and Fₗₘ(R) is the radial profile of the mode defined by Bessel functions of the first (Jₗ) and second kind (Kₗ):

$${F}_{l , m} ( R ) = \{ \begin{matrix}\frac{{J}_{l} ( uR )}{{J}_{l} ( u )} , for R < 1 \\ \frac{{K}_{l} ( uR )}{{K}_{l} ( u )} for R \geq 1\end{matrix} \qquad ( S 2 )$$

Parameter u is proportional to the transverse wavevector of a considered mode, u=a\sqrt{k₀²n_{core}²−β²}, where k₀=ω/c is the vacuum wavenumber and n core is the refractive index of the fiber core.

Equation (S1) describes the CP modes. As indicated herein, they are the Eigen modes of the fiber with the exception of the modes for which l+σ=0, i.e., the ones whose total angular momentum is zero. These exceptional modes are not even approximate solutions of the vector wave equation and as such they are not the Eigen modes of the fiber; however, it is possible to construct the Eigen modes by their equal superpositions:

ψ_{hedgehog,m}≡(ψ_{l,m,-1}+ψ_{-l,m,1})/2

ψ_{bagel,m}≡(ψ_{l,m,-1}−ψ_{-l,m,1})/2. (S3)

Therefore, strictly speaking, in the case of l+σ=0, the propagation constant β in Eq. (S1) cannot be defined. For the same reason, it is difficult to define the correction δβ_{l,-} as a correction to the propagation constant of the mode ψ_{l,m,-1}. Therefore, it is possible to reserve this symbol for a correction defined with respect to the hedgehog mode, and the correction for the bagel mode will be denoted by δβ′_{l,-}.

The fact that the modes ψ_{l,m,-1} and ψ_{-l,m,1} themselves are not the Eigen modes of the fiber shows itself in a very specific way: if the mode ψ_{l,m,-1} is injected into the fiber, then after a certain distance (say Lm) it is completely transformed into the mode ψ_{-l,m,1}. Then after propagating through an additional distance of Lm, the original mode ψ_{l,m,-1} is recovered, and the state continues to oscillate between these two modes along the fiber. This way, the case of l+σ=0 is the only one where orbital and spin angular momenta are not conserved separately along the fiber, however their sum is still conserved due to the rotational symmetry of the fiber.

The bagel and hedgehog modes are in fact members of a complete, although slightly more complicated, representation of the modes of the fiber which can be called “generalized bagel and hedgehog” (GBH PIMs). This representation of modes in a step index profile fiber is constructed as a linear superposition of CP PIMs:

l,+HE_{l+1,m}^{even}(l≥0)≡½(ψ_{l,m,1}+ψ_{-l,m,-1}),β=β_{sc}+δβ

l,−

EH_{l-1,m}^{even}(l≥1)≡½(ψ_{l,m,-1}+ψ_{-l,m,-1}),β=β_{sc}+δβ

l,+HE_{l+1,m}^{odd}(l≥0)≡½(ψ_{l,m,1}+ψ_{-l,m,-1}),β=β_{sc}+δβ

l,−

EH_{l-1,m}^{odd}(l≥1)≡½(ψ_{l,m,-1}+ψ_{-l,m,-1}),β=β_{sc}+δβ

The first index (l+1 or l−1) of these modes denotes the magnitude of the total angular momentum, and δβ_{l,±} are again corrections of the propagation constants with respect to the scalar theory. However, in the case of l+σ=0 the corrections split into two values, different for the even and odd modes (hedgehogs and bagels, respectively), which is emphasized by the prime in ^{l,-}_{β}′ the last equation. For l+σ≠0, the corrections β_{l,-} and ^{l,-}_{β}′ are equal. Specifically, the corrections can be expressed in a simple form: for all l≥0, δβ_{l,+}=I₁−I₂; for l≠1, δβ_{l,-}=^{l,-}_{β}′=I₁+I₂, and for l=1, δβ_{l,-}=2(I₁+I₂) and ^{l,-}_{β}′=0. Here I₁ and I₂ are simple integrals [1]:

$${I}_{1} = \frac{2 {Δ}^{3 / 2}}{4 aV} {\int }_{0}^{∞} {RF}_{lm} ( R ) {F}_{lm}^{′} ( R ) {f}^{′} ( R ) dR / {\int }_{0}^{∞} {RF}_{lm}^{2} ( R ) dR$$

$${I}_{2} = \frac{{l ( 2 Δ )}^{3 / 2}}{4 aV} {\int }_{0}^{∞} {RF}_{lm}^{2} ( R ) {f}^{′} ( R ) dR / {\int }_{0}^{∞} {RF}_{lm}^{2} ( R ) dR ,$$

where V=ak₀ NA is a waveguide parameter with NA being the numerical aperture of the fiber, Δ=(n_{core}²−n_{clad}²)/(2n_{core}²) is a profile height parameter and ƒ(R) is a dimensionless profile shape function. For the case of step-index fiber ƒ(R) is defined as:

$$f ( R ) = \{ \begin{matrix}0 for R < 1 \\ 1 for R \geq 1\end{matrix} \qquad ( S 4 )$$

This makes the calculation of the above integrals really simple as ƒ′(R)=δ(R−1). As a consequence, only the normalization integrals have to be calculated. Table 1 summarizes the corrections for the CP modes as well as their corresponding GBH modes in terms of I₁ and I₂ integrals. In case of l=0 that is shown separately in the table, I₂=0 and therefore the correction is just I₁. The correction I₂ is opposite for the modes ψ_{l,m,1} and ψ_{l,m,-1},

TABLE 1
Corrections δβᵢ to the scalar propagation constants βsc.

| CP modes | Corresponding GBH | δβᵢ | l values |
|---|---|---|---|
| Ψ_{0, m, ±1} | HE_{1, m}^{even}, HE_{1, m}^{odd} | I₁ | l = 0 |
| Ψ_{±l, m, ±1} | HE_{l+1, m}^{even}, HE_{l+1, m}^{odd} | I₁ − I₂ | l ≥ 1 |
| (hedgehog) | EH_{0, m}^{even}, TM_{0, m} | 2(I₁ − I₂) | l = 1 |
| (bagel) | EH_{0, m}^{odd}, TE_{0, m} | 0 | l = 1 |
| ψ_{±l, m, ∓1} | HE_{1, m}^{even}, EH_{l-1, m}^{odd} | I₁ + I₂ | l > 1 |

which means that the propagation constants of these modes are slightly different. This is a demonstration of the spin-orbit interaction, which causes rotation of the polarization vector direction if linearly polarized light with a given l propagates through the fiber, or rotation of the intensity patterns when the superposition ψ_{l,m,σ}+ψ_{-l,m,σ} propagates.

For completeness, it is possible to also compare the weak guidance corrections δβᵢ (Figures S1a,b) calculated using the integrals I₁ and I₂ and used them to evaluate higher order vectorial corrections (Figures S1e,f) from:

β_{vec}−β_{sc}=δβᵢ+(higher order corrections), (S5)

shown in FIGS.S1c,d, where β_{vec} is a fully vectorial propagation constant. The higher order corrections are on the order of ≈10⁻⁶.

The modal fields above constitute a complete approximate set of solutions of the vector-wave equation and have similar EH,HE-nomenclature to that used with the full vectorial approach. Even though the GBH PIMs form a complete basis (including the problematic l+σ=0 case), their experimental drawback is that their non-uniform polarization changes orientation periodically across the mode cross-section. As mentioned before, this leads to a selection of the CP PIMs representation for an exemplary experimental study since it is much easier to generate circularly polarized modes than modes with spatially non-uniform distribution of polarization. This choice of basis has a negligible influence on imaging performance.

Due to the very high accuracy of weak guidance approximation in an exemplary case, the propagation constants β for the above GBH modes, and also for CP modes, obtained directly from a full vectorial approach, yield virtually identical results to the scalar wave equation with weak guidance polarization corrections applied. The latter approach, however, has significant advantages over the full vectorial approach. For example, the fiber exhibits small variations of refractive index. These small variations can be readily accounted for by utilizing the perturbation theory applied to scalar modes, as described herein. The same cannot be done easily in the full vectorial description. Due to this clear advantage, it is possible to choose the scalar theory with weak guidance and perturbation corrections as a main tool in exemplary calculations.

### Deformation Operator in 3-D

The theoretical model predicts that DO does not change if the plane in which the deformed fiber lies is oriented differently, provided that the output imaging system remains oriented accordingly to the deformation imposed. If this condition is not fulfilled, the DO is accompanied by an orientation operator that rotates all output modes by the differing angle γ. To confirm this behavior, it is possible to revolve the deformed fiber (V) together with the imaging apparatus around the axis of the initially straight fiber as shown in FIG. 4a by various angles β. For this case the model predicts that γ=β. Diagonal components of DO for these cases are presented in Figure S2b. To isolate the orientation operator from these data, it is possible to efficiently utilize the fact that for γ=0, DO features symmetry of \hat{D}(+l, m)=\hat{D}(−l, m).Therefore, it is possible to search for the common angle with which output modes have to be rotated in order to maximize this symmetry. The isolated values of γ against the actual orientation β are shown in Figure S2c. The resulting DOs with the orientation operator eliminated are presented in Figure S2d, clearly confirming the orientation invariance of deformation operators.

### Proximal End Imaging

During image acquisition of images the total transmitted signal was detected using a bucket detector (integrating signal across a CCD 3) for each of the output FP generated across the grid of 75×75 positions (Figure S3a). As some may argue that this is not a real endoscopic method (the detector is not at the proximal side of the instrument), it is possible to also integrate the light returning from the fiber at the proximal end using CCD4.

The corresponding image (Figure S3b) clearly exhibits unwanted interference effects present in an exemplary imaging pathway. These originate from the light being retro-reflected on many surfaces of the exemplary geometry (including fiber facets). This does not pose any obstacles for methods relying on fluorescence emission where the retroreflected excitation wavelength can be filtered out and only the emission signal is detected. To minimize this effect, it is possible to take a reference image of a uniform reflective surface (Figure S3c). The difference of the two, shown in Figure S3d, gives an image analogous to distal end imaging (Figure S3a) but due to the more elaborate procedure it is more affected by noise. For this reason, it is possible to use the distal end imaging in an exemplary demonstrations as it makes observation of subtle effects on imaging quality more evident.

### Imaging in Arbitrary Distance from the Fiber End

Here, with highly precise knowledge of the fiber TM (particularly phases of output modes), it is possible to complement the TM with a free-space propagating operator and thus modify the location of imaging plane numerically. As shown in the sequence Figure S4, the further the image plane is set from the fiber, the larger is the accessible field of view but accordingly the resolution obtained is lower. The amount of information imaged remains the same in all the cases shown.

Figure S1. a-b, Vector corrections to β calculated from I₁ and I₂ integrals. c-d, Difference between full vector β_{vec} and scalar β_{sc}. e-f, Higher order vectorial corrections deduced by subtracting (a-b) from (c-d).

Figure S2. Influence of deformation orientation. a, Arrangements of deformed fiber used in the experiment with their roman ID number. b, Influence of curvature orientation on PIMs. c, Argument of isolated rotation operator. d, Influence of DO on PIMs after removing rotation operator.

Figure S3. Demonstration of proximal end imaging. a, Direct distal end imaging. b, Proximal end imaging with USAF target. c, reference image of reflective surface. d, Difference between (c) and (b).

Figure S4. Imaging with numerically updated TM to image at various distances behind the fiber end. The white scale bar corresponds to the size of fiber core, 50 μm.

Figure S5. Experimental transformation matrix data after processing introduced in Online Methods This example represents TM for 10 mm long segment of fiber in the representation of linearly polarized FPs. a, Polarization component S→S. b, Polarization component S→P. c, Polarization component P→S. d, Polarization component P→P.

Figure S6. Conversion matrix. λ=1064 nm, NA=0.22 and core diameter d=50 μm.

Figure S7. Converted transformation matrix for 10 mm long segment of fiber. TM is expressed in the representation of LP PIMs

Figure S8. Converted transformation matrix for 100 mm long segment of fiber. TM is expressed in the representation of LP PIMs

Figure S9. Converted transformation matrix for 100 mm long segment of fiber. TM is expressed in the representation of CP PIMs

Figure S10. Converted transformation matrix for 300 mm long segment of fiber. TM is expressed in the representation of CP PIMs

Figure S11. Optical phases of PIMs, data for the 300 mm long fiber. a, b and c, Assumed profile of refractive index, phase agreement and difference between experimentally obtained and theoretically predicted phases of PIMs respectively for the case of ideal step-index fiber. d, e and f, corresponds to a model with included dopant diffusion. g, h and i, represents correction for diffusion as well as fine index modulation (three parameters) across the fiber core.

Figure S12. Experimentally measured deformation operator corresponding to fiber deformation (V) from FIG. 4.

Figure S13. Theoretically predicted deformation operator corresponding to fiber deformation (V) from FIG. 4.

Figure S14. The experimental geometry.

Figure S15. Enhancement of wavefront correction. a, Single pixel correction. b, Enhanced wavefront correction obtained averaging 10 000 single pixel corrections.

Figure S16. Coarse misalignment compensation. a, Transmission profile of the input facet area, scanned during calibration. b, Transmission profile of input angular spectrum. c, Transmission profile of output facet. d, Transmission profile of output angular spectrum. Both (a) and (b) were up-sampled to match the resolution of output transmission profiles. The large shift of the transmission spectrum towards the top left corner in (d) was introduced into the system deliberately by adjusting the angle of incidence of the reference signal onto the CCDs. This was done in order to eliminate strong interference effects caused by multiple reflections of the reference signal within an exemplary system. e-h, The equivalent of (a-d) after applying coarse correction for misalignment.

Media SM1. Record of progression of optimization procedure introduced in Online Methods

Media SM2. Experimentally generated full set of PIMs as introduced in Online Methods. PIMs are generated in circular polarization and propagate through 10 mm long segment of fiber. Color corresponds to individual polarization components. The left column shows images of the modes prior they enter the optical fiber (recorded by CCD1). The right column shows PIMs at the output, recorded by CCD1 and CCD2.

Media SM3. Experimentally generated interfering pairs of PIMs with opposite 1 indices. PIMs are generated in circular polarization and propagate through 10 mm long segment of fiber.

Media SM4. Experimentally generated full set of PIMs as introduced in Online Methods. PIMs are generated in circular polarization and propagate through 100 mm long segment of fiber.

Media SM5. Experimentally generated interfering pairs of PIMs with opposite 1 indices. PIMs are generated in circular polarization and propagate through 100 mm long segment of fiber.

Media SM6. Invariance of deformation orientation.

Media SM7. Imaging on the distal and the proximal side of the multimode fiber. a, Record of CCD3 (at the distal end of the fiber) during imaging. It is possible to deliberately image the FPs onto the CCD chip out of focus. This is to spread the total power over a larger area thus allowing larger power to be detected and reducing overall noise. b, Progress of the image acquisition from data obtained by CCD3. c, Record of CCD4 (at the proximal side of the fiber) during imaging. Here, it is possible to collect the light returning from the fiber after reflecting off the object. Due to its propagation through the fiber the signal appears scrambled. d, Progress of the image acquisition from data obtained by CCD4. Due to space constraints both (a) and (c) represent only a fraction of the whole CCD chips' areas.

### REFERENCES

[1] Snyder, A. W. & Love, J. Optical Waveguide Theory (Springer Science & Business Media, 1983).
[2] Gloge, D. Weakly guiding fibres. Appl. Optics 10, 2252-2258 (1971).
[3] Snitzer, E. Cylindrical dielectric waveguide modes. J. Opt. Soc. Am. 51, 491-498 (1961).
[4] Liberman, V. S. & Zel′dovich, B. Y. Spin-orbit polarization effects in isotropic multimode fibres. Pure Appl. Opt. 2, 367-382 (1993).
[5] Di Leonardo, R. & Bianchi, S. Hologram transmission through multi-mode optical fibers. Opt. Express 19, 247-254 (2011).
[6] Cizmár, T. & Dholakia, K. Shaping the light transmission through a multimode optical fibre: complex transformation analysis and applications in biophotonics. Opt. Express 19, 18871-18884 (2011).
[7] Cizmár, T. & Dholakia, K. Exploiting multimode waveguides for pure fibre-based imaging. Nat. Commun. 3, 1027 (2012).
[8] Bianchi, S. & Di Leonardo, R. A multi-mode fiber probe for holographic micromanipulation and microscopy. Lab Chip 12, 635-639 (2012).
[9] Choi, Y. et al. Scanner-free and wide-field endoscopic imaging by using a single multimode optical fiber. Phys. Rev. Lett. 109, 203901 (2012).
[10] Papadopoulos, I. N., Farahi, S., Moser, C. & Psaltis, D. Focusing and scanning light through a multimode optical fiber using digital phase conjugation. Opt. Express 20, 10583-10590 (2012).
[11] Nasiri, R., Mahalati, Gu, R. Y. & Kahn, J. M. Resolution limits for imaging through multi-mode fiber. Opt. Express 21, 1656-1668 (2013).
[12] Vellekoop, I. M. & Mosk, A. P. Focusing coherent light through opaque strongly scattering media. Opt. Lett. 32, 2309-2311 (2007).
[13] Popoff, S. M. et al. Measuring the transmission matrix in optics: An approach to the study and control of light propagation in disordered media. Phys. Rev. Lett. 104, 100601 (2010).
[14] Cizmár, T., Mazilu, M. & Dholakia, K. In situ wavefront correction and its application to micromanipulation. Nature Photon. 4, 388-394 (2010).
[15] Popoff, S., Lerosey, G., Fink, M., Boccara, A. C. & Gigan, S. Image transmission through an opaque material. Nat. Commun. 1, 81 (2010).
[16] Vellekoop, I. M., Lagendijk, A. & Mosk, A. P. Exploiting disorder for perfect focusing. Nature Photon. 4, 320-322 (2010).
[17] Ji, N., Milkie, D. E. & Betzig, E. Adaptive optics via pupil segmentation for high-resolution imaging in biological tissues. Nat. Methods 7, 141-147 (2009).
[18] Papadopoulos, I. N., Farahi, S., Moser, C. & Psaltis, D. High-resolution, lensless endoscope based on digital scanning through a multimode optical fiber. Biomed. Opt. Express 4, 260 (2013).
[19] Farahi, S., Ziegler, D., Papadopoulos, I. N., Psaltis, D. & Moser, C. Dynamic bending compensation while focusing through a multimode fiber. Opt. Express 21, 22504-22514 (2013).
[20] Gambling, W. A., Payne, D. N. & Matsumura, H. Mode conversion coefficients in optical fibers. Appl. Optics 14, 1538-1542 (1975).
[21] Friesem, A. A., Levy, U. & Silberberg, Y. Parallel transmission of images through single optical fibers. In Proc. IEEE, 208-221 (1983).
[22] Kreysing, M. et al. Dynamic operation of optical fibres beyond the single-mode regime facilitates the orientation of biological cells. Nat. Commun. 5, 5481 (2014).
[23] von Hoyningen-Huene, J., Ryf, R. & Winzer, P. LCoS-based mode shaper for few-mode fiber. Opt. Express 21, 18097-18110 (2013).
[24] Carpenter, J., Eggleton, B. J. & Schröder, J. 110×110 optical mode transfer matrix inversion. Opt. Express 22, 96-101(2014).
[25] Leach, J., Padgett, M., Barnett, S., Franke-Arnold, S. & Courtial, J. Measuring the orbital angular momentum of a single photon. Phys. Rev. Lett. 88, 257901 (2002).
[26] http://complexphotonics.dundee.ac.uk/.
[27] Bliokh, K. Y., Niv, A., Kleiner, V. & Hasman, E. Geometrodynamics of spinning light. Nature Photon. 2, 748-753 (2008).
[28] Lyytikainen, K. et al. Dopant diffusion during optical fibre drawing. Opt. Express 12, 972-977 (2004).
[29] Gibson, B. C. et al. Controlled modification and direct characterization of multimode-fiber refractive-index profiles. Appl. Optics 42, 627-633 (2003).
[30] Skinner, B. J. & Appleman, D. E. Melanophlogite, a Cubic Polymorph of Silica. Am. Mineral. 48, 854-867 (1963).
[31] Cizmár, T. & Dholakia, K. Tunable bessel light modes: engineering the axial propagation. Opt. Express 17, 15558-15570 (2009).
[32] Gerchberg, R. W. & Saxton, W. O. A practical algorithm for the determination of the phase from image and diffraction plane pictures. Optik 35, 237-246 (1972).

1-14. (canceled)

15. A method for designing a light transmission system using a multimode optical fiber, comprising:
predicting light transmission properties of the multimode optical fiber by numerically modelling a transmission matrix of a particular fiber; and
designing the light transmission system based on the prediction.

16. The method according to claim 15, further comprising correcting the transmission matrix for at least one of fiber misalignments, a fiber radius, or a numerical aperture.

17. The method according to claim 15, wherein the numerical modelling is based on diffraction-limited focal points (FPs).

18. The method according to claim 17, further comprising synthesising a set of the FPs across a grid to obtain raster scanning of an object during an image acquisition.

19. The method according to claim 15, wherein a performance of the numerical modelling includes a correction to compensate for a curvature of the multimode optical fiber.

20. The method according to claim 19, further comprising modifying the transmission matrix for a straight fiber by a deformation operator associated with a curved fiber.

21. The method according to claim 20, wherein the performance of the numerical modelling of a non-uniformly bent fiber includes a use of a product of deformation operators corresponding to sufficiently short fiber segments in which a curvature is considered as being approximately constant.

22. The method according to claim 19, wherein the correction accounts for a deformation of a cross-section of the multimode optical fiber due to bending.

23. The method according to claim 19, further comprising selecting a refractive index and Poisson's ration of the multimode optical fiber to modify a strength of deformation-induced changes in the transmission matrix.

24. The method according to claim 15, wherein the numerical modelling is associated with circularly polarised modes.

25. The method according to claim 15, wherein the numerical modelling includes modelling for a diffusion of a dopant between a core and a cladding of the multimode optical fiber.

26. A method for providing a light transmission system, comprising:
providing a multimode optical fiber;
predicting light transmission properties of the multimode optical fiber by numerically modelling a transmission matrix of a particular fiber; and
coupling the multimode optical fiber to a light source and to a light detector based on the prediction of the prediction of the light transmission properties.

27. An endoscope comprising:
a multimode optical fiber provided based on a prediction of light transmission properties of the multimode optical fiber using numerically modelling a transmission matrix of a particular fiber.

28. A signal transmission system comprising:
a light transmission system including a multimode optical fiber which is provided based on a prediction of light transmission properties of the multimode optical fiber using numerically modelling a transmission matrix of a particular fiber.
